(19) United States
(12) Patent Application Publication
(10) Pub. No.: US 2011/0303692 A1
(43) Pub. Date: Dec. 15, 2011

(54) MEDICINE DISPENSER, METHOD OF DISCHARGING MEDICINE, AND AUTOMATIC MEDICINE PACKING MACHINE INCLUDING THE DISPENSER

(75) Inventor: Jun Ho Kim, Daegu (KR)

(73) Assignee: JVM CO., LTD., Daegu (KR)

(21) Appl. No.: 13/156,123

(22) Filed: Jun. 8, 2011

(30) Foreign Application Priority Data
Jun. 9, 2010 (KR) 10-2010-0054166
Oct. 14, 2010 (KR) 10-2010-0100248

(51) Int. Cl. B65G 59/00; B65D 83/04

(52) U.S. Cl. 221/1; 221/279; 221/199; 221/174; 221/200; 221/280; 221/124

(57) ABSTRACT

The present disclosure provides a medicine dispenser, which can detect the number of medicines such that an accurate number of medicines can be discharged for packing, a medicine discharging method, and an automatic packing machine including the medicine dispenser. The medicine dispenser includes a frame and a medicine transfer unit attached to the frame and transferring medicines one pill at a time to an outside of the medicine dispenser. The medicine transfer unit includes a detection unit that detects the number of medicines dropping from a medicine container to be packed, and a transfer unit that pushes the medicines, the number of which is detected by the detection unit, into a packing passage connected to a packing unit to transfer the medicines to the packing unit.

### CROSS-REFERENCE TO RELATED APPLICATION

This application claims the benefit under 35 U.S.C. §119 of Korean Patent Application No. 10-2010-0054166, filed on Jun. 9, 2010 & Korean Patent Application No. 10-2010-0100248, filed on Oct. 14, 2010 in the Korean Intellectual Property Office, the entirety of which is incorporated herein by reference.

### BACKGROUND

1. Technical Field

The present disclosure relates to a medicine dispenser, a medicine discharging method, and an automatic packing machine including the medicine dispenser. More particularly, the present disclosure relates to a medicine dispenser, which can detect the number of medicines such that an accurate number of medicines can be discharged for packing, a medicine discharging method, and an automatic packing machine including the medicine dispenser.

2. Description of the Related Art

Conventionally, an automatic packing machine receives medicine from a plurality of cassettes, which receive medicines such as tablets or capsules, and consecutively packs the medicine into doses.

FIG. 1 is a schematic front view of a conventional automatic packing machine.

Referring to FIG. 1, the automatic packing machine includes a body 100, a plurality of cassettes 110, which are arranged at an upper portion of the body 100 and receive medicines such as tablets or capsules having various sizes and shapes, a hopper 130 disposed at a lower portion of the body 100 and collecting the medicines discharged from the cassettes 110, a printer 140 for printing various data on the surface of a wrapping paper for packing the medicines, and a packing unit 150 that packs the medicines in the wrapping paper when collected in the hopper 130.

In the conventional automatic medicine packing machine, the cassette includes a cassette body for receiving medicines in the form of tablets or capsules having various sizes and shapes, a distribution block rotatably disposed inside the cassette body to separate and discharge the medicines, a cassette support receiving a motor for driving the distribution block and supporting the cassette body, and a partition member provided to the cassette body to discharge the medicines in a predetermined amount when the medicines are discharged by the distribution block.

The distribution block is formed on an outer peripheral surface thereof with a plurality of discharge grooves, through which medicines are discharged from the cassette body to the outside of the cassette body. Here, the partition member blocks the discharge groove so as to allow a predetermined amount of medicines to be discharged.

Examples of the cassette are disclosed in Japanese Unexamined Patent Publication No. Hei (09)-266940, U.S. Pat. No. 5,803,309, and the like. These conventional cassettes are configured to allow discharge of medicines having the same size and shape such as a circular or elliptical shape.

However, in some cases, a prescription is made to provide medicines having different shapes such as half-cut tablets. The medicines having different shapes such as a half-cut tablet obtained by cutting a flat circular tablet into two halves cannot be suitably discharged through the conventional cassette due to the non-uniform shape thereof.

Thus, when a prescription is made to provide a medicine having a different shape such as a half-cut tablet, the medicine must be manually packed instead of using an automatic medicine packing machine. As a result, not only does packing such medicines require lots of time and endeavor, but also provides a possibility of contamination of the medicines during manual classification thereof.

Therefore, there is a need for a medicine dispenser that can detect the number of medicines so as to allow an accurate number of medicines to be discharged for packing, whereby not only medicines of a constant shape but also medicines of different shapes can be discharged and packed.

### BRIEF SUMMARY

The present disclosure is directed to solving the problems of the related art as described above, and embodiments of the present disclosure provide a medicine dispenser, which may accurately dispense not only medicines having regular shapes but also medicines having different or irregular shapes such as half-cut tablets or capsules one pill at a time by vibration, a medicine discharging method, and an automatic packing machine including the medicine dispenser.

In accordance with one aspect of the present disclosure, a medicine dispenser capable of discharging medicines one pill at a time by vibration includes: a frame; and a medicine transfer unit attached to the frame and transferring medicines one pill at a time to an outside of the medicine dispenser. Here, the medicine transfer unit includes a detection unit that detects the number of medicines dropping from a medicine container to be packed, and a transfer unit that pushes the medicines, the number of which is detected by the detection unit, into a packing passage connected to a packing unit to transfer the medicines to the packing unit.

When the number of medicines detected by the detection unit exceeds the number of medicines to be packed, the dropped medicines are pushed into a recovery passage to be recovered instead of being packed.

The detection unit may include sensors arranged in the discharge passage through which the medicines pass when dropping from the container.

Each of the sensors may be a photosensor comprising a light emitting element and a light receiving element to detect the number of medicines passing through the discharge passage. Here, a plurality of light emitting elements and a plurality of light receiving elements are arranged in a line such that the light emitting elements face the light receiving elements, respectively.

The detection unit may include a scale that receives the dropped medicines and measures a total weight of the dropped medicines.

The transfer unit may include a swing hopper swingable in opposite directions to push the dropped medicines into the packing passage to transfer the medicines towards the packing unit to pack the medicines or into the recovery passage to transfer the medicines towards the recovery unit to recover the medicines.

The medicine dispenser may further include a dividing hopper located under the swing hopper. The dividing hopper includes the packing passage connected to the packing unit, the recovery passage connected to the recovery unit, and a medicine holding section formed between the packing passage and the recovery passage to allow the dropped medicines to temporarily remain on the medicine holding section.

The medicine holding section may be provided with a scale that receives the dropped medicines and measures a total weight of the dropped medicines.

The medicine holding section may have an arcuate upper surface and the swing hopper may have an arcuate lower surface corresponding to the upper surface of the medicine holding section so as not to create a gap between the upper surface of the medicine holding section and the lower surface of the swing hopper when the swing hopper is swung.

The discharge passage may be formed at an upper center thereof with a pin member that instantaneously reduces a falling speed of the medicines so as to allow the sensors to accurately measure the number of medicines dropping from the container.

The medicine dispenser may further include a vibration unit mounted on the frame to generate vibration to move the medicines. The vibration unit includes a vibrator for generating vibration and a plate attached to the vibrator to vibrate together with the vibrator.

The medicine dispenser may further include a pendulum rotatably mounted on the frame to uniformly spread the medicines when the medicines overlap each other while being moved by vibration.

The pendulum may include a swing rod swingably placed on holding grooves formed on the frame, and a catch board suspended from the swing rod and uniformly spreading the medicines when the medicines are moved in an overlapped state on the plate.

The medicine dispenser may further include a vibration unit mounted on the frame to generate vibration to move the medicines. The vibration unit includes a vibrator for generating vibration and a plate attached to the vibrator to vibrate together with the vibrator. The plate has a groove guiding movement of the medicines by vibration and the catch board has a shape corresponding to the groove and is separated from the groove.

The catch board may have a pentagonal shape, a lower side of which is cut into a V-shaped vertex, or may be cut to have a circular shape at a center of a lower side thereof.

The frame may include a gate unit, an opening degree of which is adjusted to allow the medicines to pass one pill at a time therethrough, and a drive unit which drives the gate unit to open or close the gate unit.

The number of medicines dropping from the plate may be measured by a sensor, and the plate may be formed at a distal end thereof with a pin member to instantaneously reduce a falling speed of the medicines so as to allow the sensor to efficiently and accurately count the number of medicines dropping from the plate.

In accordance with another aspect of the present disclosure, a medicine dispenser capable of discharging medicines one pill at a time by vibration includes: a frame; a vibration unit generating vibration to move medicines; a support unit supporting the frame and the vibration unit while preventing the vibration from being transferred from the vibration unit to the frame; and a pendulum rotatably mounted on the frame to uniformly spread the medicines when the medicines are moved in an overlapped state by the vibration. The pendulum includes a swing rod swingably placed on holding grooves formed on the frame and a catch board suspended from the swing rod to uniformly spread the medicines when the medicines are moved in an overlapped state on the plate.

In accordance with a further aspect of the present disclosure, a medicine dispenser capable of discharging medicines one pill at a time by vibration includes: a frame; and a medicine transfer unit attached to the frame and transferring medicines one pill at a time to an outside of the medicine dispenser. Here, the medicine transfer unit includes a detection unit that detects the number of medicines dropping from a medicine container to be packed, and a transfer unit that transfers the medicines, the number of which is detected by the detection unit, to a packing passage connected to a packing unit after making the medicines temporarily remaining in the transfer unit.

The detection unit may include photosensors arranged in a discharge passage through which the medicines pass when transferred to the medicine transfer unit.

The transfer unit may include a medicine holding member that causes the dropped medicines to temporarily remain thereon and is then swung to the right or left within a body of the transfer unit to transfer the medicines in a direction opposite the swing direction of the medicine holding member.

The medicine holding member may have a fan-shaped cross-section with a rotational shaft located as a vertex of the fan shape, and an upper surface of the medicine transfer unit and an inner surface of the body around the medicine transfer unit may have arcuate shapes corresponding to each other so as not to create a gap between the upper surface of the medicine holding member and the inner surface of the body when the medicine holding member is swung.

In accordance with yet another aspect of the present disclosure, a medicine discharging method capable of accurately discharging a specific number of medicines to be packed includes: causing medicines to temporarily remain at a certain place when the medicines to be packed are individually moved from a medicine container, followed by pushing the medicines into a packing unit if the number of medicines remaining at the certain place equals the number of medicines to be packed.

The method may further include waiting for additional medicines until the number of medicines remaining at the certain place equals the number of medicines to be packed, if the number of medicines remaining at the certain place is less than the number of medicines to be packed, and pushing the medicines towards a recovery unit so as not to be packed by the packing unit if the number of medicines remaining at the certain place exceeds the number of medicines to be packed.

The number of medicines remaining at the certain place may be counted by at least one of a process of measuring the number of passing medicines during movement of the medicines, and a process of measuring a weight of the medicines remaining at the certain place.

In accordance with yet another aspect of the present disclosure, an automatic packing machine for consecutively packing various kinds of medicines into doses according to prescriptions includes a plurality of cassettes arranged at an upper portion of a body of the automatic packing machine and containing medicines having various sizes and shapes; the medicine dispenser capable of discharging the medicines one pill at a time by vibration; a hopper disposed at a lower portion of the body and collecting the medicines dropping from the medicine dispenser through the cassettes; a printer printing various data regarding the medicines on a surface of a wrapping paper for packing the medicines; and a packing unit for packing the medicines collected by the hopper using the wrapping paper.

The medicine dispenser may be disposed together with the plurality of cassettes at the upper portion of the body.

In accordance with yet another aspect of the present disclosure, a medicine dispenser capable of discharging medicines one pill at a time by vibration includes: a frame; a vibration unit mounted on the frame and moving medicines by vibration; and a medicine transfer unit transferring the medicines discharged one pill at a time from the vibration unit to an outside of the medicine dispenser. The medicine transfer unit includes a detection unit provided to a discharge passage, through which the medicines discharged from the vibration unit pass, to detect the number of medicines passing through the discharge passage; a holding member causing the medicines, which have passed through the detection unit, to temporarily remain on the holding member inside the discharge passage; and an opening/closing member located downstream of the holding member to open a packing passage if the number of medicines measured by the detection unit and placed on the holding member equals a predetermined number of medicines and to open a recovery passage if the number of medicines measured by the detection unit and placed on the holding member differs from the predetermined number of medicines.

The opening/closing member may be rotatably located between the packing passage and the recovery passage to open the packing passage while closing the recovery passage if the number of medicines on the holding member equals the predetermined number of medicines and to open the recovery passage while closing the packing passage if the number of medicines on the holding member differs from the predetermined number of medicines.

The detection unit may include sensors arranged in the discharge passage through which the medicines pass.

Each of the sensors may be a photosensor comprising a light emitting element and a light receiving element to detect the number of medicines passing through the discharge passage.

The medicine dispenser may further include a medicine input unit mounted on the frame upstream of the vibration unit to supply the medicines towards the vibration unit.

The medicine input unit may be a cylindrical feeder that moves the medicines from a receiving section along a spiral path through vibration.

The spiral path may have at least one crevice formed at an inner periphery thereof.

The vibration unit may include a vibrator generating vibration in a linear direction and a plate attached to the vibrator to vibrate together with the vibrator in the linear direction.

The plate may include a groove section for moving the medicines in a line.

The groove section may include at least one inclined surface to form at least one step on a bottom surface thereof, and may have a V or U-shaped cross-section to allow the medicines to move along a central line of the groove section.

The medicine dispenser may further include a recovery barrel located downstream of the recovery passage to receive the medicines recovered through the recovery passage.

Each of the holding member and the opening/closing member may be rotated within a predetermined angle by a corresponding motor.

In accordance with yet another aspect of the present disclosure, a medicine discharging method capable of accurately discharging a specific number of medicines to be packed includes: causing medicines to temporarily remain at a certain place by a holding member when the medicines to be packed are individually moved from a medicine container; opening a packing passage located downstream of the holding member to supply the medicines towards a packing unit through the packing passage, if the number of medicines remaining at the certain place equals the number of medicines to be packed; and releasing a remaining state of the medicines to transfer the medicines towards the open packing passage.

The medicine discharging method may further include waiting for additional medicines until the number of medicines remaining at the certain place equals the number of medicines to be packed, if the number of medicines remaining at the certain place is less than the number of medicines to be packed; opening the recovery passage downstream of the holding member to recover the medicines if the number of medicines remaining at the certain place exceeds the number of medicines to be packed; and releasing a remaining state of the medicines on the holding member to transfer the medicines towards the open packing passage.

The number of medicines remaining at the certain place may be counted by detecting the number of passing medicines while the medicines are moved towards the holding member.

In accordance with yet another aspect of the present disclosure, an automatic packing machine for consecutively packing various kinds of medicines into doses according to prescriptions includes a plurality of cassettes arranged at an upper portion of a body of the automatic packing machine and containing medicines having various sizes and shapes; the medicine dispenser capable of discharging the medicines one pill at a time by vibration; a hopper disposed at a lower portion of the body to collect the medicines dropping from the medicine dispenser through the cassettes; a printer printing various data regarding the medicines on a surface of a wrapping paper for packing the medicines; and a packing unit for packing the medicines collected by the hopper using the wrapping paper.

The medicine dispenser may be disposed together with the plural cassettes at an upper portion of the body.

As such, embodiments of the present disclosure provides a medicine dispenser and an automatic packing machine including the same which may accurately dispense not only medicines having regular shapes but also medicines having different or irregular shapes such as half-cut tablets or capsules one pill at a time by vibration, a medicine discharging method.

Thus, the medicine dispenser, the medicine discharging method, and the automatic medicine packing machine allow an accurate number of medicines to be transferred to a packing unit, thereby enabling an accurate number of medicine packing operations, irrespective of the shapes of medicines to be packed.

### BRIEF DESCRIPTION OF THE DRAWINGS

FIG. 1 is a schematic front view of a conventional automatic packing machine;

FIG. 2 and FIG. 3 are a perspective view and a side sectional view of a medicine dispenser according to a first exemplary embodiment of the present disclosure, which is mounted inside an automatic packing machine;

FIG. 4 to FIG. 6 are a perspective view, a side view and a plan view of a main part of the medicine dispenser according to the first exemplary embodiment of the present disclosure, respectively;

FIG. 7 is a partial sectional view of a damping member included in the medicine dispenser according to the first exemplary embodiment of the present disclosure;

FIG. 8 and FIG. 9 are a perspective view and a side view of a plate included in the medicine dispenser according to the first exemplary embodiment of the present disclosure, respectively;

FIG. 10 is a perspective view of a medicine input unit included in the medicine dispenser according to the first exemplary embodiment of the present disclosure;

FIG. 11 is a side sectional view illustrating operation of the medicine input unit;

FIG. 12, FIG. 13 and FIG. 14 are a side view, a front view and a plan view of a medicine dispenser according to an exemplary embodiment of the present disclosure mounted on the automatic packing machine, respectively;

FIG. 15 is a partial perspective view of a passage included in the automatic packing machine in which the medicine dispenser according to the exemplary embodiment of the present disclosure is mounted;

FIG. 16 is a perspective view of a main part of the passage separated from the automatic packing machine in which the medicine dispenser according to the exemplary embodiment of the present disclosure is mounted;

FIG. 17 is a perspective view of a main part of a medicine dispenser according to a second exemplary embodiment of the present disclosure;

FIG. 18 is a view illustrating operation of a gate member of the medicine dispenser according to the second exemplary embodiment of the present disclosure;

FIGS. 19 and 20 are an exploded perspective view and a side sectional view of a medicine input unit included in the medicine dispenser according to the second exemplary embodiment of the present disclosure;

FIG. 21 is a schematic front view of a medicine transfer unit included in the medicine dispenser according to the second exemplary embodiment of the present disclosure;

FIG. 22 is a schematic front view of a modification of the medicine transfer unit included in the medicine dispenser according to the second exemplary embodiment of the present disclosure;

FIG. 23 is a plan view of a discharge passage including a sensor unit in the medicine dispenser according to the second exemplary embodiment of the present disclosure;

FIG. 24 shows operation of the sensor unit of the discharge passage in the medicine dispenser according to the second exemplary embodiment of the present disclosure;

FIG. 25 is a side view of a medicine dispenser according to a modification of the second exemplary embodiment of the present disclosure;

FIG. 26 is a plan view of a plate of the medicine dispenser according to the modification of the second exemplary embodiment of the present disclosure;

FIG. 27 is a schematic perspective view of a medicine dispenser according to a third exemplary embodiment of the present disclosure;

FIG. 28 is a cross-sectional view of a main part of the medicine dispenser according to the third exemplary embodiment of the present disclosure;

FIG. 29 to FIG. 31 are front views illustrating operation of a medicine transfer unit of the medicine dispenser according to the third exemplary embodiment of the present disclosure;

FIG. 32 to FIG. 34 are front views illustrating operation of a medicine transfer unit of a medicine dispenser according to the fourth exemplary embodiment of the present disclosure;

FIG. 35 is a perspective view of a medicine dispenser according to a fifth exemplary embodiment of the present disclosure;

FIG. 36 is a side view of the medicine dispenser according to the fifth exemplary embodiment of the present disclosure;

FIG. 37 is a schematic front view of a medicine transfer unit included in the medicine dispenser according to the fifth exemplary embodiment of the present disclosure; and

FIG. 38 is a schematic side view of an automatic packing machine including the medicine dispenser according to the fifth exemplary embodiment of the present disclosure.

### DETAILED DESCRIPTION

Hereinafter, exemplary embodiments of the present disclosure will be described in detail with reference to the accompanying drawings.

Herein, the term “medicines having different shapes” refers to medicines that have irregular or asymmetrical shapes such as semicircular or semielliptical half-cut tablets, which are obtained by cutting circular or elliptical tablets into halves, and are difficult to automatically dispense through a conventional cassette. Further, the term “medicine” should be construed as meaning not only the medicines having different shapes, but also any kind of medicine, for examples narcotic drugs, which require particular treatment and thus cannot be dispensed through existing cassettes despite being a whole tablet, or which is not frequently prescribed so that use of the cassettes for the corresponding medicines becomes inefficient.

In the following embodiments, a medicine dispenser refers to a device capable of accurately arranging and discharging, one pill at a time, not only medicines having a regular shape such as tablets or capsules but also medicines having irregular or different shapes. In order to allow medicines to be accurately discharged one pill at a time, it is necessary to arrange a cluster of medicines such that the medicines are separated a predetermined distance from each other. If the medicines are arranged too close to each other, there is a possibility of simultaneous discharge of one or more medicines due to inertia.

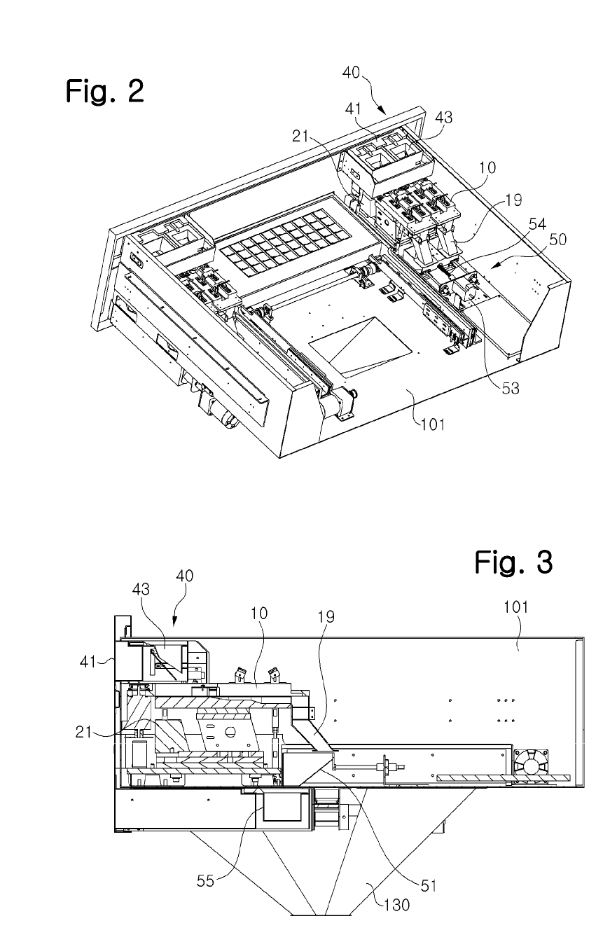

Next, a medicine dispenser according to a first exemplary embodiment will be described with reference to FIG. 2 to FIG. 11.

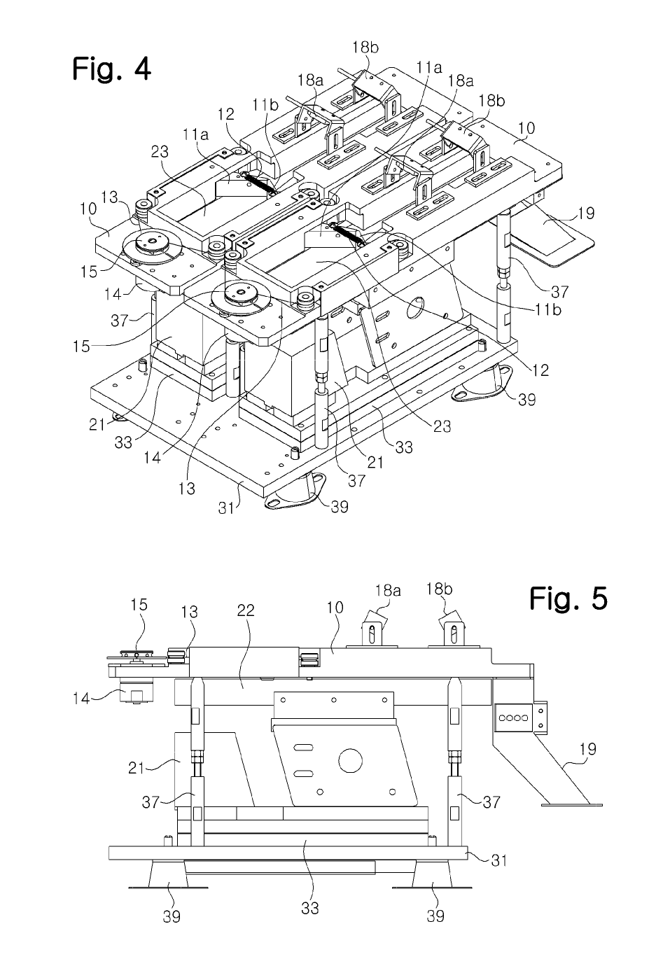

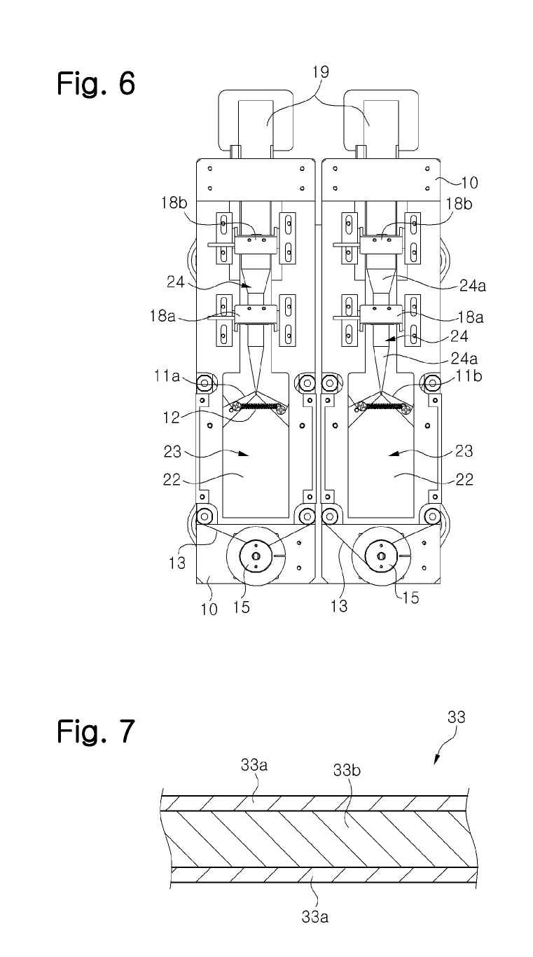

FIG. 2 and FIG. 3 are a perspective view and a sectional view of the medicine dispenser according to the first exemplary embodiment, which is mounted inside an automatic packing machine. FIG. 4 to FIG. 6 are a perspective view, a side view and a plan view of a main part of the medicine dispenser according to the first exemplary embodiment, respectively. FIG. 7 is a partial sectional view of a damping member included in the medicine dispenser according to the first exemplary embodiment.

Referring to FIG. 2 to FIG. 6, the medicine dispenser according to the first exemplary embodiment includes a frame 10 to which an openable gate unit is coupled, a vibration unit disposed at a lower portion of the frame 10 to move medicines via vibration, and a support unit that supports the frame 10 and the vibration unit.

According to the first embodiment, the medicine dispenser further includes a medicine input unit 40 mounted on the frame 10 to randomly supply desired medicines to the vibration unit one pill at a time, and a medicine transfer unit 50 that transfers the medicines to a hopper 130 when the medicines are discharged one pill at a time through the vibration unit.

Referring to FIG. 4 to FIG. 6, the frame 10 includes the gate unit configured to allow adjustment of the degree of opening/closing such that medicines can be passed one pill at a time therethrough, a drive unit driving the gate unit to open or close the gate unit, one or more sensors 18a, 18b for monitoring transfer of the medicines, and a discharge passage 19 for guiding discharge of the medicines.

The gate unit includes a pair of gate members 11a, 11b disposed at left and right sides thereof, and a resilient member 12 connected between the gate members 11a, 11b to force the gate members 11a, 11b to be kept in a closed state.

The drive unit serves to open the gate members 11a, 11b against resilient force of the resilient member 12. The drive unit includes pulling strings 13 respectively connected to the pair of gate members 11a, 11b and a rotational member 15 for winding or unwinding the pulling strings 13 via the drive motor 14.

First sensors 18a, 18b monitoring whether medicines pass through the gate unit, and second sensors 18a, 18b monitoring whether the medicines are discharged from the plate 22 may be mounted on the frame. In addition to the sensors 18a, 18b, although not shown in the drawings, other sensors for monitoring transfer of medicines may be provided to a point through which the medicines are randomly supplied from a medicine receiving unit such as a medicine hopper to the medicine dispenser, and to a point through which the medicines are discharged outside of the medicine dispenser.

Any kind of sensor, for example, photosensors may be used as the sensors 18a, 18b so long as the sensors can monitor transfer of medicines having different shapes.

The vibration unit includes a vibrator 21 for generating vibration and a plate 22 attached to the vibrator 21 to vibrate together with the vibrator. The vibrator 21 may have any configuration known in the art, and a detailed description thereof will thus be omitted.

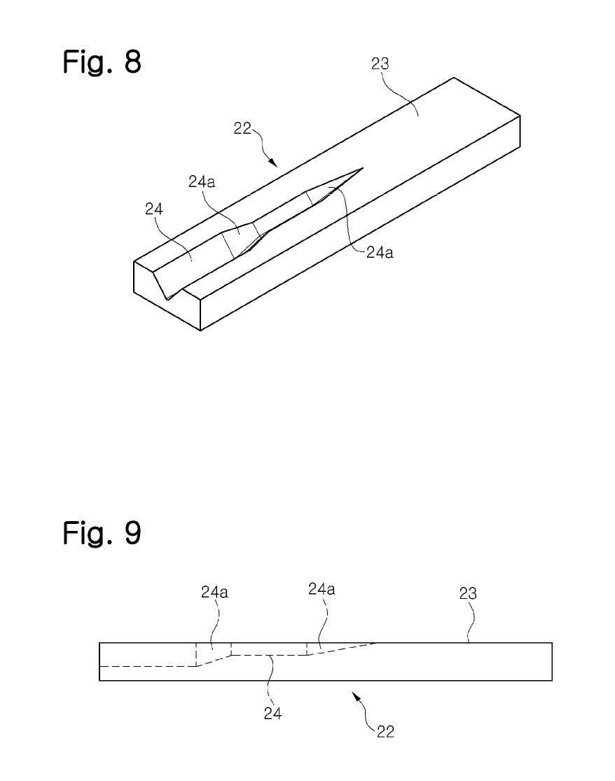

FIGS. 8 and 9 are a perspective view and a side view of the plate included in the medicine dispenser according to the first exemplary embodiment.

The plate 22 is vibrated by the vibrator 21 to minutely move medicines thereon. The plate 22 includes a receiving section 23 surrounded by the frame 10 and the gate members 11a, 11b to receive medicines supplied from the exterior medicine hopper (not shown), and a groove section 24 that moves the medicines having passed through the gate members 11a, 11b to a discharge passage 19.

In FIG. 3, the plate 22 is slightly inclined towards the right side, to which the discharge passage 19 is attached, so that the medicines on the plate 22 can be gradually moved towards the discharge passage 19 as the plate 22 is vibrated by the vibration unit.

The groove section 24 includes at least one inclined plane 24a, which forms at least one step on the groove section 24. While a medicine passes through the inclined plane 24a, the moving speed of the medicine increases, causing the medicine to be further separated from another medicine that immediately follows the medicine. As such, the inclined plane 24a on the groove section 24 separates the medicines from each other during discharge to the outside, so that discharge of the medicines can be accurately controlled.

The groove section 24 may have a U or V-shaped cross section so as to allow the medicines to move along a central line of the groove section 24. Further, when the plate 22 is formed with a plurality of inclined planes 24a, the inclined planes may be designed to have the same or different angles, as needed.

The plate 22 may be formed of a metallic material, a non-metallic material, or a combination thereof. In particular, since the moving speed of the medicines having different shapes can be changed depending on the kind of material forming an upper surface of the plate 22 contacting the medicines, the material of the plate 22 may be selected in consideration of the moving speed of the medicines having different shapes.

For example, if the upper surface of the plate 22 is made of a metallic material, medicines will have a relatively high moving speed due to a low coefficient of friction of the plate for the same degree of vibration, and if the upper surface of the plate 22 is made of a non-metallic material such as plastic, the medicines will have a relatively low moving speed due to a large coefficient of friction of the plate for the same degree of vibration.

Further, the plate 22 may be formed of a combination of a metallic material and a non-metallic material such that some part of the plate 22 is formed of the metallic material and the other part of the plate 22 is formed of the non-metallic material. In this case, the non-metallic material may be applied to a portion of the plate 22, for example, the receiving section 23 side, which is upstream of the plate 22 in the moving direction of the medicines having different shapes and where a relatively low moving speed of the medicine is preferable, and a metallic material may be applied to a portion of the plate 22, for example, the groove section 24 side, which is downstream of the plate 22 and where a relatively high moving speed of the medicines is preferable.

When the plate 22 is made of two different materials in this manner, the two different materials may be applied only to an upper surface of the plate 22, which will be brought into contact with medicines having different shapes.

The support unit includes a bottom plate 31 on which the vibration unit is mounted, a damping member 33 interposed between the vibration unit and the bottom plate 31, and a plurality of support rods 37 which support the frame 10. Support legs 39 may be attached to a lower surface of the bottom plate 31 and used when placing the medicine dispenser inside the automatic packing machine as needed.

Although the medicine dispenser is illustrated as including two pairs of frames 10 and vibration units arranged in parallel to each other on the bottom plate 31 in FIG. 2 to FIG. 4, the medicine dispenser may include a single or three pairs of frames 10 and vibration units arranged in parallel to each other.

According to the first embodiment, the damping member 33 may be formed of a material which can maintain the shape of the damping member without being tilted towards one side by sustaining the weight of a component mounted on the damping member, can stop movement of the plate as soon as vibration is stopped, and can prevent vibration from being transferred to the outside during operation of the vibration unit.

The damping member 33 interposed between the vibration unit and the bottom plate 31 may be formed of an elastic material, for example, silicone or an elastomer, which preferably has a penetration degree of 10 to 100, more preferably 30 to 80. If the degree of penetration of the silicone or elastomer member used for the damping member 33 is less than 10, the damping member 33 cannot sufficiently prevent vibration of the vibration unit from being transferred to the bottom plate 31. If the degree of penetration exceeds 100, the plate 22 of the vibration unit can be disadvantageously inclined in an undesired direction or can continue to vibrate due to inertia even after operation of the vibration unit is stopped.

Further, as shown in FIG. 7, the damping member 33 may be formed by stacking silicone (foamed silicone) or elastomer materials having different degrees of penetration one above another. Here, first damping layers 33a stacked in upper and lower layers preferably have a degree of penetration of 5 to 50, more preferably 10 to 40, and a second damping layer 33b interposed between the first damping layers 33a has a degree of penetration of 60 to 100, more preferably 60 to 80.

When the damping member 33 is formed by stacking the damping layers one above another as shown in FIG. 7, the second damping layer 33b having a high degree of penetration may securely prevent vibration of the vibration unit from being transferred therethrough, and the first damping layers 33a having a low degree of penetration may secure the plate 22 and the like disposed above the damping member 33 while preventing generation of vibration due to inertia after operation of the vibration unit is stopped. When the damping member 33 is formed by stacking the damping layers, the first damping layer 33a and the second damping layer 33b may be formed of different materials.

Alternatively, the damping member 33 interposed between the vibration unit and the bottom plate 31 may be formed of an elastic material, for example, silicone or an elastomer, which preferably has a hardness of 1 to 10, more preferably 2 to 9. If the silicone or elastomer used for the damping member 33 has hardness less than 1, the damping member cannot sufficiently prevent vibration of the vibration unit from being transferred to the bottom plate 31, and if the silicone or elastomer has a hardness greater than 9, the plate 22 of the vibration unit can be disadvantageously inclined in an undesired direction or can continue to vibrate due to inertia even after operation of the vibration unit is stopped.

Further, as shown in FIG. 5, the damping member 33 may be formed by stacking silicone (foamed silicone) or an elastomer having different degrees of penetration one above another. Here, first damping layers 33a stacked in upper and lower layers may have lower hardness than a second damping layer 33b interposed between the first damping layers 33a.

When the damping member 33 is formed by stacking the damping layers one above another as shown in FIG. 5, the second damping layer 33b having high hardness may securely prevent vibration of the vibration unit from being transferred therethrough, and the first damping layers 33a having low hardness may secure the plate 22 and the like disposed above the damping member 33 while preventing generation of vibration due to inertia after operation of the vibration unit is stopped. When the damping member 33 is formed by stacking the damping layers, the first damping layer 33a and the second damping layer 33b may be formed of different materials.

Although the damping member 33 is illustrated as being placed between the vibration unit and the bottom plate 31 in FIGS. 2 to 4, the damping member may be positioned between the bottom plate 31 and an inner structure 101 of the automatic packing machine when the medicine dispenser is mounted inside the packing machine.

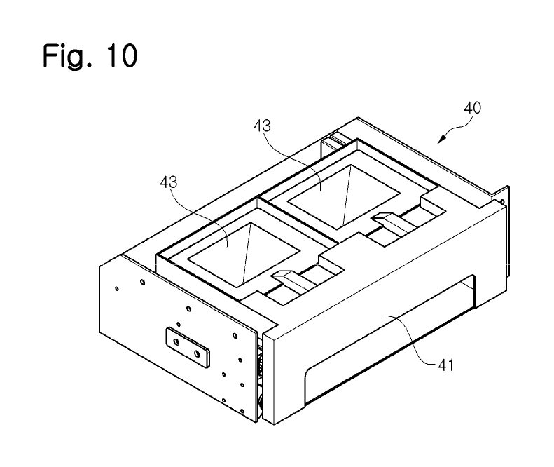

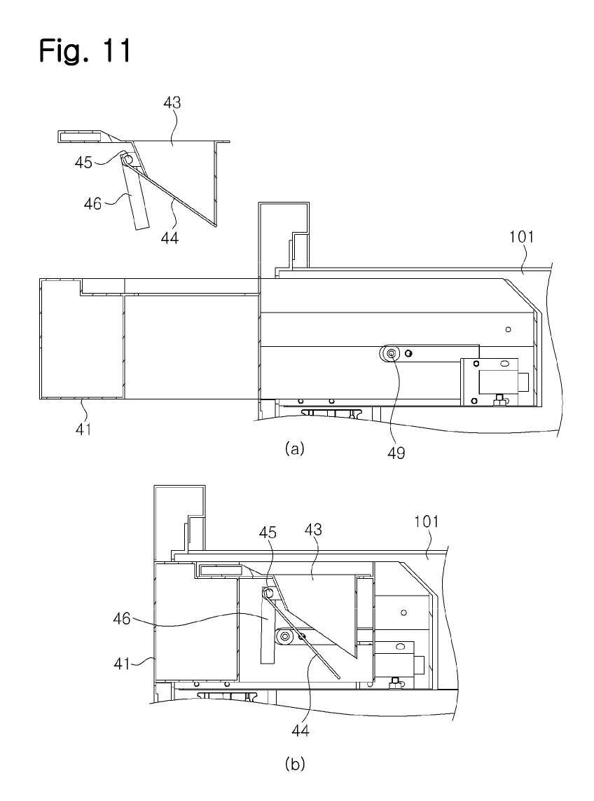

FIG. 10 is a perspective view of the medicine input unit included in the medicine dispenser according to the first exemplary embodiment and FIG. 11 is a side sectional view illustrating operation of the medicine input unit.

The medicine input unit 40 includes a medicine input body 41 slidably provided to one side of the automatic packing machine, and cup members 43 detachably mounted on the medicine input body 41.

The medicine input body 41 is slidable between an open position, at which the cup member 43 can be detached from or mounted on the medicine input body 41 as shown in FIG. 11(a), and a supply position, at which medicines received in the cup member 43 can be supplied towards the vibration unit as shown in FIG. 11(b).

The bottom of the cup member 43 can be opened or closed by an opening/closing door 44 which can be rotated about a hinge shaft 45. The opening/closing door 44 is integrally formed with the hinge shaft 45 and a latch member 46. When the medicine input body 41 is placed at the opening position, the opening/closing door 44 closes the bottom of the cup member 43 via a resilient member (not shown). When the medicine input body 41 is placed at the supply position, the latch member 46 is brought into contact with a protrusion 49 formed on the automatic packing machine and rotates the hinge shaft 45, thereby opening the opening/closing door 44.

As shown in FIG. 11(a), since the cup member 43 is detachably mounted on the medicine input body 41, medicines may be simply supplied for packing by placing the medicines in the cup member 43 and mounting the cup member on the medicine input body 41.

As shown in FIG. 11(b), the medicines received in the cup member 43 are randomly supplied to the receiving section 23 of the plate 22 disposed below the cup member as soon as the opening/closing door 44 is opened.

As described above, the medicines supplied to the receiving section 23 are moved towards the groove section 24 of the plate 22 by vibration and discharged one pill at a time therethrough. Here, the medicines randomly supplied to the receiving section 23 may be linearly moved towards the groove section 24 by the gate unit.

When discharged one pill at a time through the groove section 24 and the discharge passage 19, the medicines are sent to the hopper 130 by the medicine transfer unit 50 and then packed. Referring again to FIGS. 2 and 3, the medicine transfer unit 50 includes an assistant hopper 51 disposed to move linearly in a forward or rearward direction (in a left or right direction in FIG. 3), a linear movement unit driving the assistant hopper 51, and a recovery barrel 55 which recovers remaining medicines after packing.

The assistant hopper 51 is linearly moved between a reversed position where medicines discharged one pill at a time from the medicine dispenser can drop into the hopper 130 during packing and an advanced position (position shown in FIGS. 2 and 3) where the medicines discharged from the medicine dispenser can drop into the recovery barrel 55 such that the remaining medicines can be recovered by the recovery barrel 55 after packing.

The linear movement unit includes a motor 53 and a screw rod 54 rotated by the motor 53, and is configured to allow the assistant hopper 51 to move linearly forwards or rearwards as the screw rod 54 is rotated in the clockwise or counterclockwise direction.

Like the cup member 43, the recovery barrel 55 may be detachably mounted on the medicine transfer unit.

It should be understood that the medicine dispenser according to the first embodiment may be used independent of the automatic packing machine and a plurality of medicine dispensers may be provided to the automatic packing machine.

When installed in the automatic packing machine, the medicine dispenser is configured to allow medicines, which are received in the cassettes within the automatic packing machine, to be discharged and supplied by a desired number of pills to the packing machine according to a packing cycle.

Although two pairs of medicine dispensers are illustrated as being installed at right and left sides on the internal structure 101 of the automatic packing machine in FIG. 2, it should be noted that the present disclosure is not limited thereto.

When a plurality of medicine dispensers is installed in a single automatic packing machine to dispense different kinds of medicines for packing at the same time, these medicine dispensers may be arranged to discharge the medicines having different shapes to a common hopper (not shown).

Further, when a plurality of medicine dispensers is installed in a single automatic packing machine, a single vibrator 21 may be used to vibrate a plurality of plates 22 at the same time. Here, when the medicine dispensers are configured to allow the plurality of plates 22 to be vibrated by a single vibrator 21, discharge of medicines by the gate units may be separately controlled in each of the medicine dispensers.

Further, it should be understood that the medicine dispenser according to the first embodiment may be used to dispense not only medicines having different shapes but also general medicines such as circular or elliptical tablets or capsules.

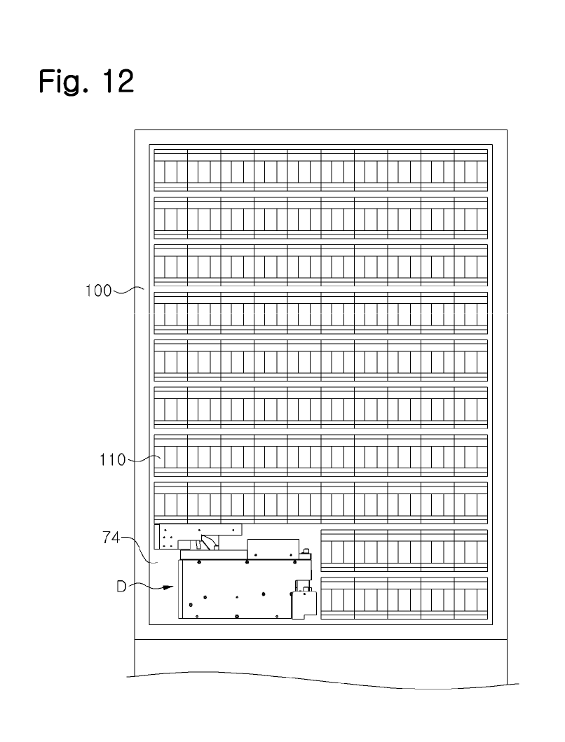

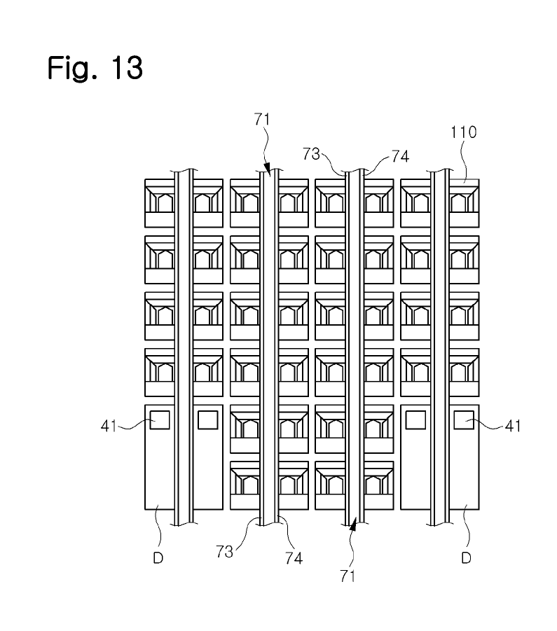

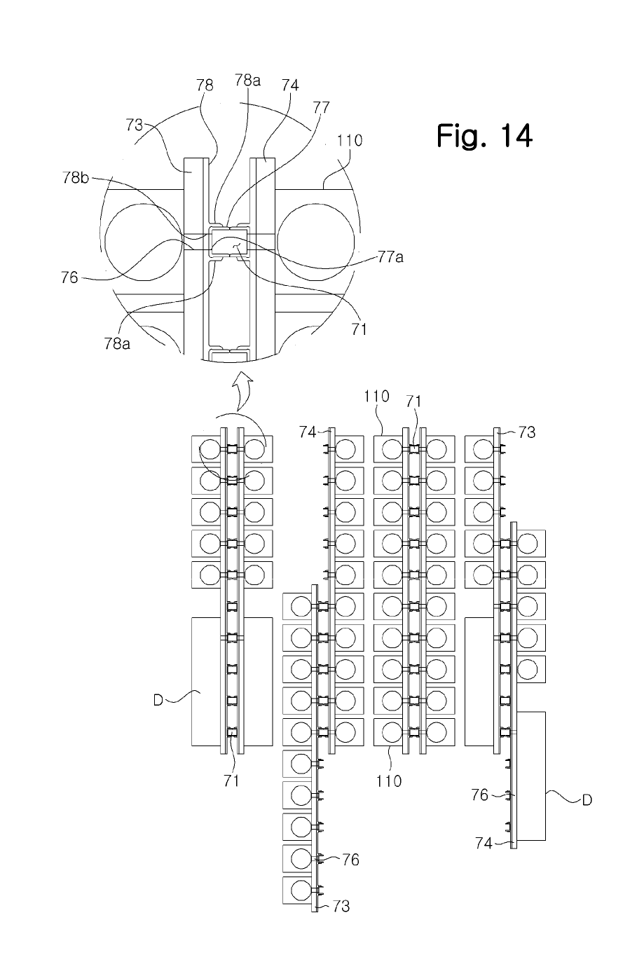

As shown in FIGS. 12 to 16, a medicine dispenser D according to an exemplary embodiment may be arranged together with cassettes 110 within the body of the automatic packing machine. FIGS. 12, 13 and 14 are a side view, a front view and a plan view of the medicine dispenser mounted on the automatic packing machine, respectively. FIG. 15 is a partial perspective view of a passage included in the automatic packing machine in which the medicine dispenser is mounted, and FIG. 16 is a perspective view of a main part of the passage separated from the automatic packing machine in which the medicine dispenser is mounted.

Referring to FIGS. 12 to 14, when installed in the automatic packing machine, the medicine dispenser D is disposed together with the plurality of cassettes 110 containing medicines in the form of tablets or capsules having various sizes and shapes inside the body 100. In this case, the medicine dispenser D may be disposed under the cassettes 110.

The automatic packing machine including the medicine dispenser D includes a plurality of passages 71, which are composed of a plurality of left and right partitions 73, 74 to which the cassettes 110 and the medicine dispenser D are attached. The cassettes 110 and the medicine dispenser D are attached to the left and right partitions 73, 74.

As shown in FIG. 14, the left and right partitions 73, 74 are configured to allow the cassettes 110 and the medicine dispenser D to be individually separated from the body 100 of the automatic packing machine.

In the automatic packing machine, the passages 71 may be partitioned to define narrower spaces by passage members 77 in a space formed between the facing left and right partitions 73, 74.

In other words, each of the partitioned passages 71 for discharging medicines is formed by the passage members 77 detachably attached to the inner sides of the facing left and right partitions 73, 74. The passage members 77 are attached to the inner sides of the left and right partitions 73, 74 to define an elongated space in the vertical direction inside the left and right partitions 73, 74, such that medicines supplied from the cassettes 110 linearly arranged in the vertical direction and from the medicine dispenser D can be discharged through the common passage 71.

Each of the passage members 77 has a substantially C or U-shaped cross-section and forms a rectangular or circular passage 71 together another passage member 77 facing the passage member 77.

As shown in FIGS. 15 and 16, in order to allow the passage member 77 to be detachably attached to the left and right partitions 73, 74, each of the left and right partitions 73, 74 may be provided with a guide member 78 into which the passage member 77 is slidably fitted.

Referring to FIG. 16, a single guide member 78 is formed with two pairs of guiding portions 78a protruding therefrom such that two passage member 77 are fitted into the guide portions 78a. However, it should be understood that the number of passage members fitted into a single guide member can be changed according to design and does not limit the scope of the invention.

Further, in order to allow medicines discharged from the cassettes 110 and the medicine dispenser D to drop through the passages 71, the passage members 77 and the guide members 78 are also formed with through-holes 77a, 78b corresponding to medicine discharge holes 76, which are formed on the left and right partitions 73, 74.

Since such configuration of the passage of the automatic packing machine allows the left and right partitions 73, 74 to be separately withdrawn from the packing machine, the number of cassettes 110 simultaneously withdrawn from the automatic packing machine can be cut in half as compared with the automatic medicine packing machine in the related art, thereby allowing rapid and continuous packing. Furthermore, since the interior of the passages 71 is exposed, cleaning of the packing machine can become significantly convenient. Further, since the passage members 77 constituting the passages 71 can be separated from the left and right partitions 73, 74 for cleaning or replacement, cleaning of the packing machine can be more conveniently performed.

The medicine dispenser D is configured to supply medicines by a desired number of pills towards the packing unit according to a packing cycle by which medicines received in the cassettes 110 within the automatic packing machine are discharged and packed.

Meanwhile, although four medicine dispensers D are illustrated as being disposed together with the cassettes 110 at lower sides of the left and right partitions 73 in FIGS. 13 and 14, it should be understood that the present disclosure is not limited thereto and the number and positions of medicine dispensers D may be changed as needed.

Obviously, the medicine dispenser according to the present disclosure may be used to dispense not only medicines having different shapes but also general medicines such circular or elliptical tablets or capsules.

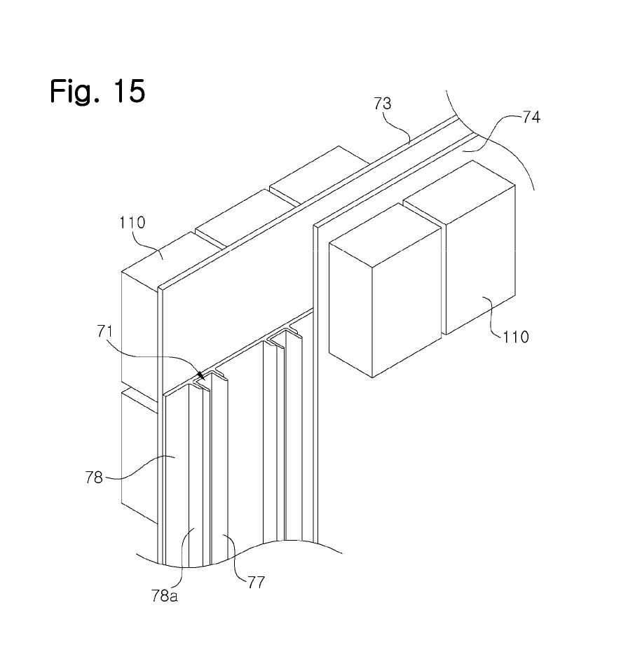

Next, a medicine dispenser according to a second exemplary embodiment of the present disclosure will be described with reference to FIGS. 17 to 24.

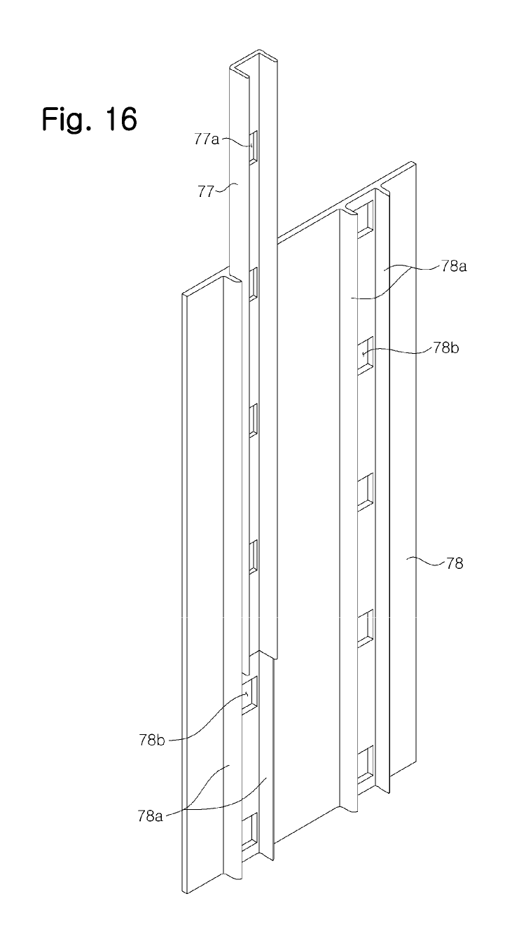

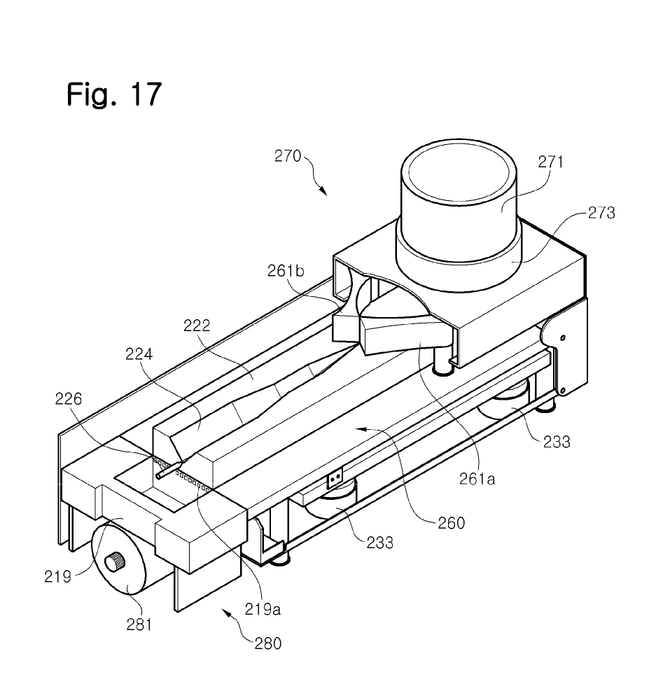

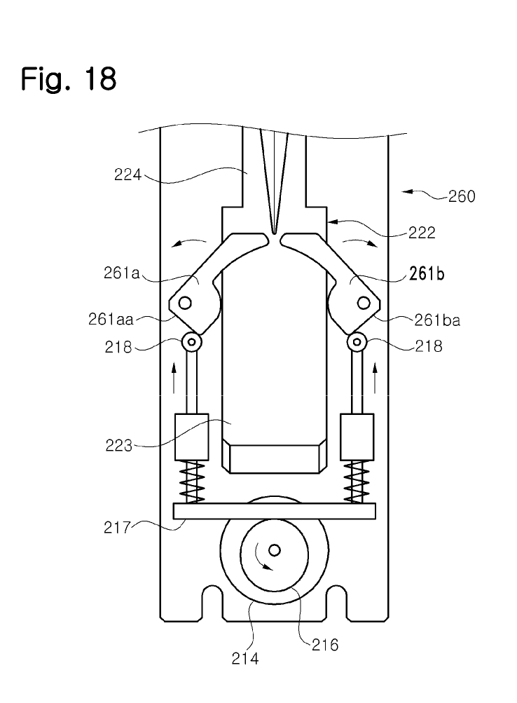

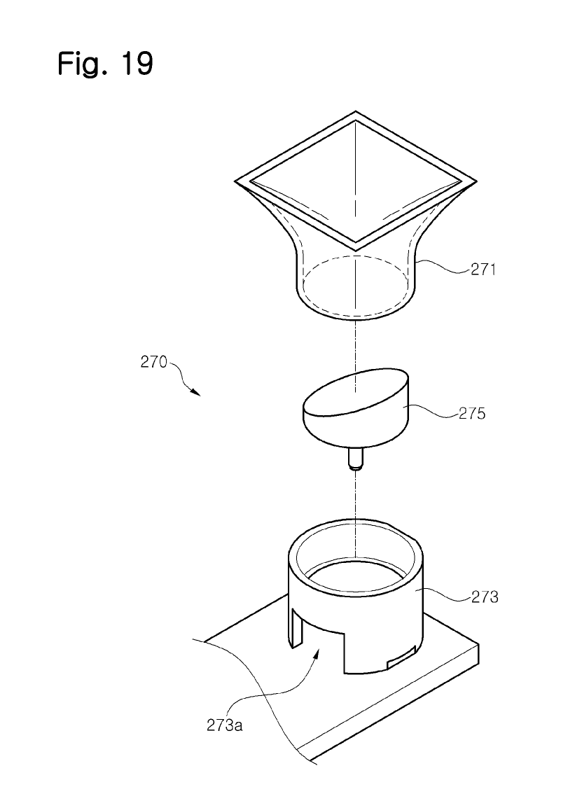

FIG. 17 is a perspective view of a main part of the medicine dispenser according to the second exemplary embodiment and FIG. 18 is a view illustrating operation of a gate member of the medicine dispenser according to the second exemplary embodiment. FIGS. 19 and 20 are an exploded perspective view and a side sectional view of a medicine input unit included in the medicine dispenser according to the second exemplary embodiment. FIG. 21 is a schematic front view of a medicine transfer unit included in the medicine dispenser according to the second exemplary embodiment and FIG. 22 is a schematic front view of a modification of the medicine transfer unit.

Referring to FIG. 17, like the medicine dispenser according to the first embodiment described above, the medicine dispenser according to the second embodiment includes a frame 260 to which an openable gate unit is coupled, a vibration unit disposed at a lower portion of the frame 260 to move medicines via vibration, a support unit that supports the frame 260 and the vibration unit, a medicine input unit 270 disposed above the frame 260 to randomly supply desired medicines one pill at a time to the vibration unit, and a medicine transfer unit 280 that transfers the medicines to a hopper 130 when the medicines are discharged one pill at a time through the vibration unit.

According to the first embodiment, two medicine dispensers are disposed in a pair below the cassettes, whereas separate medicine dispensers are arranged together with the cassettes within the automatic packing machine in the second embodiment.

In the second embodiment, the frame 260 includes a gate unit that is configured to allow adjustment of the degree of opening/closing such that medicines can be passed one pill at a time therethrough, a drive unit driving the gate unit to open or close the gate unit, one or more sensors for monitoring regular transfer of the medicines, and a discharge passage 219 for guiding the medicines to be discharged outside, as in the medicine dispenser according to the first embodiment.

According to the first embodiment, drive force is transferred from the drive motor to the gate members via the pulling strings to open or close the gate members, whereas the gate members are opened or closed by cam members in the second embodiment.

Referring to FIG. 18, the gate unit according to the second embodiment includes a pair of gate members 261a, 261b disposed at left and right sides, and a resilient member (not shown) connected between the gate members 261a, 261b to force the gate members 261a, 261b to be kept in a closed state. The resilient member may be disposed to connect the gate members 261a, 261b to each other as in the first embodiment, or may be separately disposed around a rotational shaft of each of the gate members 261a, 261b.

The drive unit serves to open the gate members 261a, 261b against resilient force of the resilient member. The drive unit includes a cam member 216 rotated by the drive motor 214, a substantially U or C-shaped drive member 217 linearly moved by the cam member 216, and rollers 218 disposed at distal ends of the drive member 217 to adjoin rolling surfaces 261aa, 261ba of the gate members 261a, 261b, respectively. As the cam members 216 are rotated by rotation of the drive motor 214, the drive member 217 linearly moves. At this time, the rollers 218 of the drive members 217 compress the rolling surfaces 261aa, 261ba of the gate members 261a, 261b so as to pivot the drive member 217, so that the gate members 261a, 261b can be opened or closed.

The drive member 217 is compressed towards the cam members 216 by a resilient member such as a coil spring to always be in close contact with the cam members 216.

Although not shown in the drawings, the frame 260 may be provided with at least one sensor which ascertains whether medicines pass through the gate unit. Although there is some difference between the discharge passage 219 of the second embodiment and the discharge passage 219 of the first embodiment in terms of shape, both passages have the same function to act as a path through which medicines having different shapes discharged from the plate, that is, dropped from the plate, are transferred to a medicine transfer unit 280, and are thus denoted by the same reference numeral.

Further, as in the medicine dispenser according to the first embodiment, the vibration unit according to the second embodiment includes a vibrator 221 for generating vibration and a plate 222 attached to the vibrator 221 to vibrate together with the vibrator.

Herein, since the vibrator 221 and the plate 222 in the medicine dispenser according to the second embodiment are the same as or similar to those of the first embodiment, like components will be denoted by like reference numerals and detailed descriptions thereof will be omitted.

Further, according to the second embodiment, the support unit includes a bottom plate 231 on which the vibration unit is mounted, and a damping member 233 interposed between the vibration unit and the bottom plate 231, as in the medicine dispenser according to the first embodiment. However, unlike the first embodiment in which the frame is supported by the plurality of support rods, the dispenser according to the second embodiment may be provided with a casing 235 that surrounds the medicine dispenser so as not to expose the internal structure of the medicine dispenser and supports the bottom plate 231 and the frame 210 within the casing 235. FIG. 17 shows the internal structure of the medicine dispenser, from which a side plate is removed from the casing 235.

In the second embodiment, the material of the damping member 233 is the same material as that of the first embodiment, and a detailed description thereof is thus omitted. Here, although the damping member 233 is illustrated as being positioned between the vibration unit and the bottom plate 231 in the first embodiment, two damping members may be arranged in upper and lower layers such that the bottom plate 231 is interposed therebetween and the vibrator 221 may be connected to these two damping members.

Further, referring to FIGS. 19 and 20, the medicine input unit 270 according to the second embodiment includes an upper input body 271, which has a barrel (see FIG. 17) or funnel (see FIGS. 19 and 20) shape and receives medicines, a lower input body 273 formed under the upper input body 271 and having an opening 273a through which medicines are discharged, and a rotatable opening/closing member 275 disposed inside the lower input body 273 and rotated to open and close the opening 273a by a motor 274.

As shown in the drawings, the rotatable opening/closing member 275 has an inclined upper surface, so that the opening 273a can be repeatedly opened and closed when the rotatable opening/closing member 275 is rotated. Further, the rotatable opening/closing member 275 may prevent the medicines received in the upper and lower input bodies 271, 273 from being agglomerated and blocked during discharge of the medicines.

Although the upper and lower input bodies 271, 273 are illustrated as being separately manufactured and assembled in FIG. 19, it should be understood that the upper and lower input bodies 271, 273 may be formed as a single integrated member.

Further, as shown in FIG. 20, a rotational shaft 274a of the motor 274 may be detachably coupled to a rotational shaft 275a of the rotatable opening/closing member 275. Such a detachable configuration of the rotatable opening/closing member 275 facilitates cleaning or maintenance of the medicine dispenser.

Medicines input to the upper input body 271 are randomly supplied to a receiving section 223 of a plate 222 whenever the opening 273a is opened by the rotatable opening/closing member 275. As described above in the first embodiment, the medicines randomly supplied to the receiving section 223 are linearly moved towards the groove section 224 of the plate 222 by vibration and discharged one pill at a time therethrough. Here, the medicines randomly supplied to the receiving section 223 may be linearly moved towards the groove section 224 by the gate unit.

When discharged one pill at a time through the groove section 224 and the discharge passage 219, the medicines are sent to the hopper 130 by the medicine transfer unit 280 and then packed.

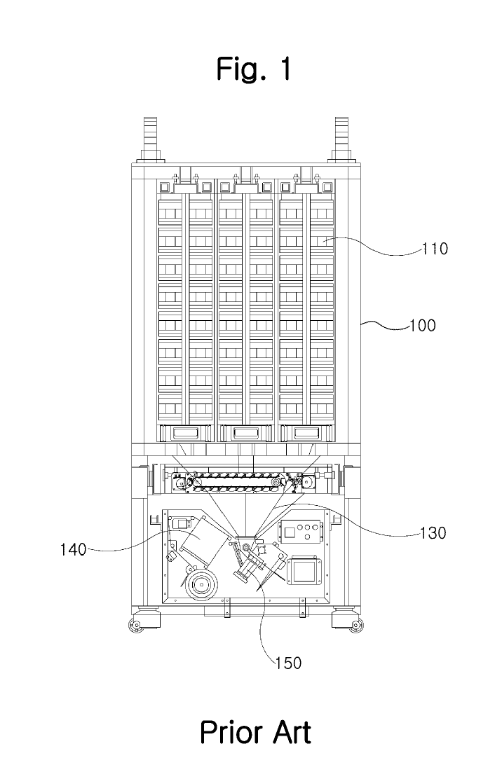

Referring to FIG. 21, the medicine transfer unit 280 includes a rotatable discharge member 281 pivotably located under the discharge passage 219 of the frame 260, a connection passage 283 formed under the rotatable discharge member 281 to transfer medicines discharged through the rotatable discharge member 281 to the hopper 130 (see FIG. 1), and a recovery passage 285 formed under the rotatable discharge member 281 to recover the medicines, which are not transferred to the hopper 130, to a recovery barrel (not shown).

The rotatable discharge member 281 may be installed to be rotated within a predetermined angle by a motor. The rotatable discharge member 281 is formed therein with a transfer passage 281a which penetrates the rotatable discharge member 281 in the vertical direction, so that the medicines discharged through the discharge passage 219 can be selectively transferred to the connection passage 283 or the recovery passage 285 by adjusting the angle of the rotatable discharge member 281.

Referring to FIG. 22 which shows a modification of the medicine transfer unit 280, another rotatable discharge member 286 is illustrated. In the embodiment shown in FIG. 21, the rotatable discharge member 281 has the transfer passage 281a formed therein, whereas the rotatable discharge member 286 shown in FIG. 11 has a pair of receiving sections 286a concavely formed to face each other in the diametrical direction.

The receiving sections 286a temporarily receive medicines dropped from the plate 222. When a predetermined number of medicines are dropped to one of the receiving sections 286a, the rotatable discharge member 286 selectively transfers the medicines from the receiving section 286a to the recovery passage 285 (upon rotation in the clockwise direction) or to the connection passage 283 (upon rotation in the counterclockwise direction) while rotating 180 degrees in the clockwise or counterclockwise direction.

The number of medicines dropped from the plate 222 may be counted by sensors disposed in the discharge passage 219. As shown in FIGS. 17, 23 and 24, the sensor may be a photosensor including a light emitting element 219a and a light receiving element 219b.

The plate 222 is formed at a distal end thereof with a pin member 226 to instantaneously reduce a falling speed of the medicines such that the sensors in the discharge passage 219 can efficiently and accurately count the number of medicines falling through the discharge passage 219. Since the medicine moves over the pin member 226 to the left or right of the pin member 226 when dropped from the distal end of the groove section 224 of the plate, the falling speed of the medicine can be instantaneously reduced. As a result, the medicine can be more securely sensed by the sensors in the discharge passage 219.

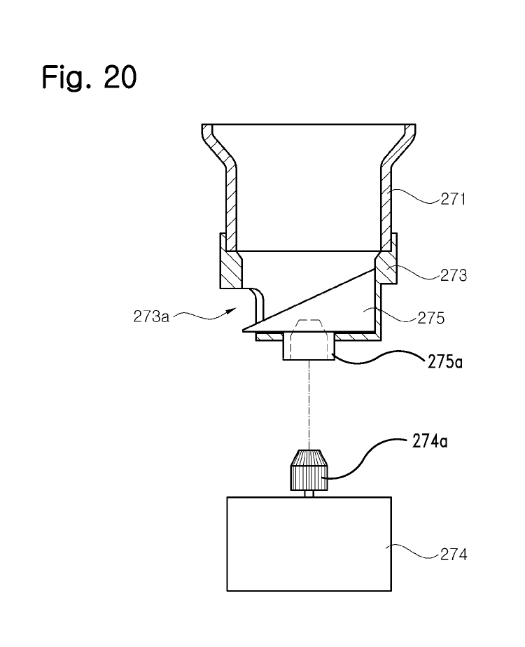

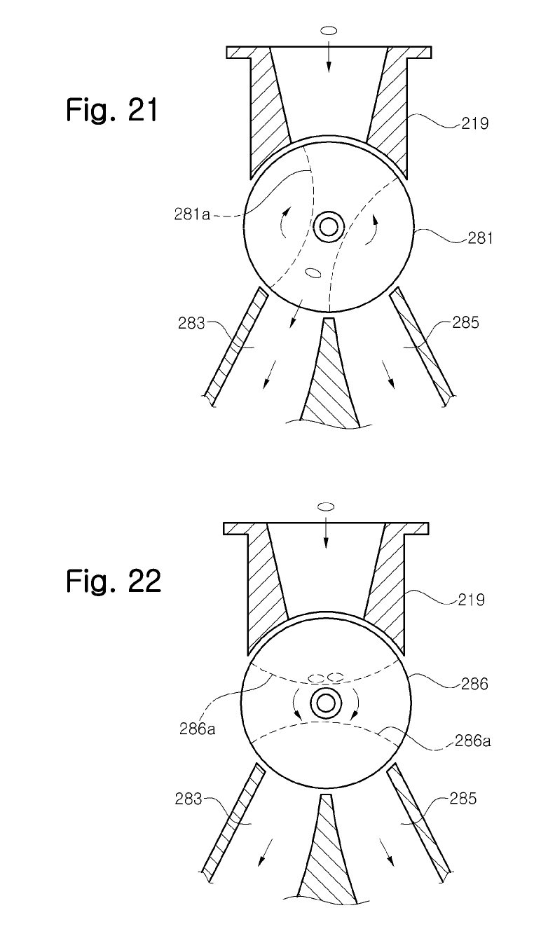

According to one exemplary embodiment, the sensors may be realized by a linear arrangement of a plurality of light emitting elements 219a and a plurality of light receiving elements 219b. For example, when the discharge passage 219 includes 10 light emitting elements 219a and 10 light receiving elements 219b as shown in FIGS. 23 and 24, the number of medicines can be accurately determined even when two medicines are dropped from the plate substantially at the same time.

Referring to FIG. 24, the medicine meets and moves over the pin member 226 to the left or right of the pin member 226 when dropped from the plate 222. At this time, if two medicines are dropped therefrom substantially at the same time, one of the medicines is dropped through the right side of the pin member 226 and the other is dropped through the left side of the pin member or vice versa.

If the sensor is comprised of a single light emitting element 219a and a single light receiving element 219b, the sensor may detect drop of medicines and cannot distinguish the number of medicines dropping from the plate even in the case where two medicines are dropped at the same time.

However, according to the embodiment of the present disclosure, since the discharge passage is provided with the plurality of light emitting and receiving elements 219a and 219b, for example, a medicine at the left side may be detected by second to fourth light emitting and receiving elements 219a and 219b from the leftmost side and a medicine at the right side may be detected by seventh to ninth light emitting and receiving elements 219a and 219b from the left side when the medicines are dropped from the plate. At this time, since the fifth and seventh light emitting and receiving elements 219a and 219b do not detect the medicine, the sensor can identify that two medicines are dropped from the plate. In other words, when dropping of the medicines is detected by the plurality of light emitting and receiving elements 219a and 219b, it can be determined that two medicines are dropped substantially at the same time if there are light emitting and receiving elements 219a and 219b that do not detect dropping of the medicine.

Further, according to the embodiment, the plate 222 may be made of a transparent material and receive the sensor therein. The medicine dispenser according to the embodiment may further include an openable cover (not shown) on the plate 222. The cover may also be made of a transparent material and the sensor may be located inside the cover instead of the plate.

The medicine dispenser according to the second embodiment is configured to supply a desired number of medicines towards the automatic packing machine according to a packing cycle in which medicines received in the cassettes 110 within the automatic packing machine are discharged and packed. Here, it should be understood that the present disclosure is not limited thereto and the number and positions of medicine dispensers may be changed as needed.

Obviously, the medicine dispenser according to the second embodiment of the present disclosure may be used to dispense not only medicines having different shapes but also general medicines such circular or elliptical tablets or capsules.

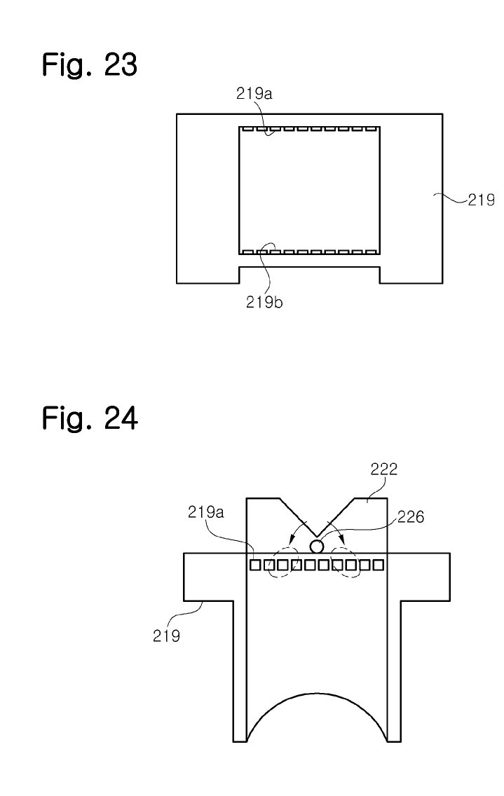

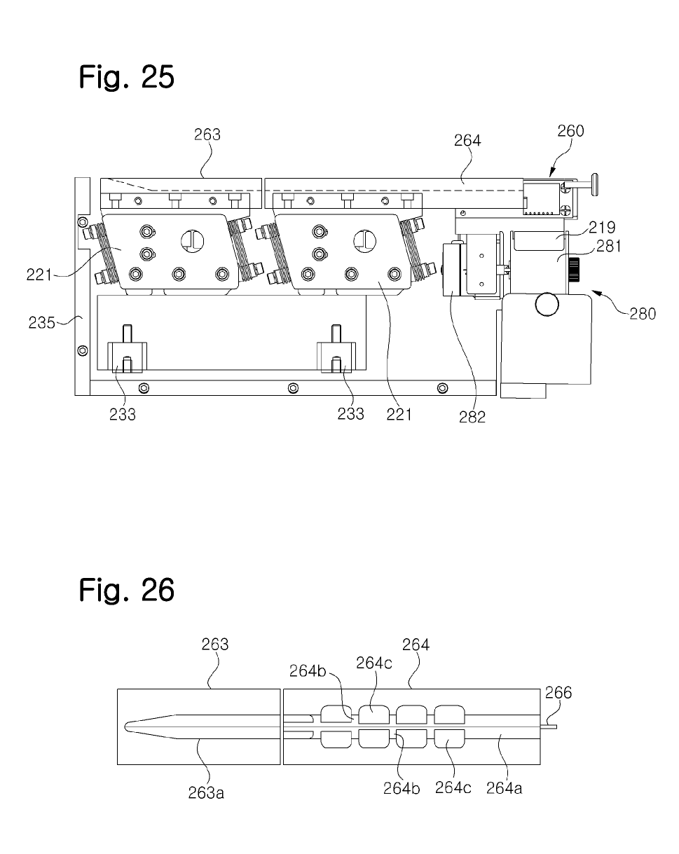

FIG. 25 is a side view of a medicine dispenser according to a modification of the second exemplary embodiment, and FIG. 26 is a plan view of a plate of the medicine dispenser according to the modification of the second exemplary embodiment.

In the modification of the second embodiment, the plate of the medicine dispenser is constituted by two plates, which are vibrated at different frequencies by separate vibrators 221. Other elements of the medicine dispenser according to the modification are the same as those of the second embodiment. Thus, like elements are denoted by like reference numerals and detailed descriptions thereof are omitted.

As shown in FIGS. 25 and 26, the plate according to the modification may include a first plate 263 located corresponding to the receiving section 223 and a second plate 264 located corresponding to the groove section 224.

The first plate 263 and the second plate 264 are separated from each other and are formed with first and second grooves 263a, 264a. The first and second grooves 263a and 264a are linearly arranged.

As described above, the first and second plates 263, 264 are vibrated by separate vibrators 221, which can make the first and second plates 263, 264 vibrating at different vibrating speeds. For example, the second plate 264 from which medicines are discharged may vibrate at a higher speed than the first plate 263 into which the medicines are input.

Further, in order to prevent elliptical or circular medicines from rolling in the groove and thus being agglomerated, the second groove 264a may be formed with at least one protuberance 264b and at least on depression 264c. Alternatively, the second groove 264a may be formed with one of the protuberance 264b and the depression 264c.

Further, as described above, the plate 264 is formed at a distal end thereof with a pin member 266 so as to instantaneously reduce the falling speed of the medicines such that the sensor can accurately count the number of falling medicines. Since the medicine meets and moves over the pin member 266 to the left or right of the pin member 266 when dropped from the distal end of the second groove 264a of the plate, the falling speed of the medicine can be instantaneously reduced. As a result, the medicine can be more securely sensed by the sensor in the discharge passage 219.

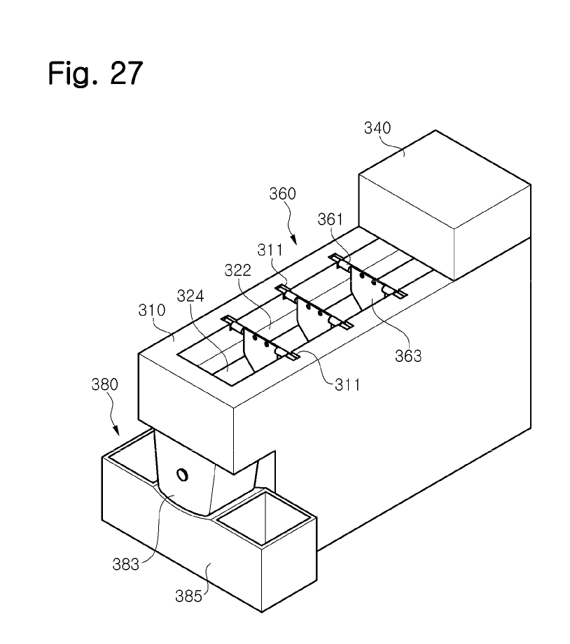

Next, a medicine dispenser according to a third exemplary embodiment of the present disclosure will be described with reference to FIG. 27 to FIG. 31.

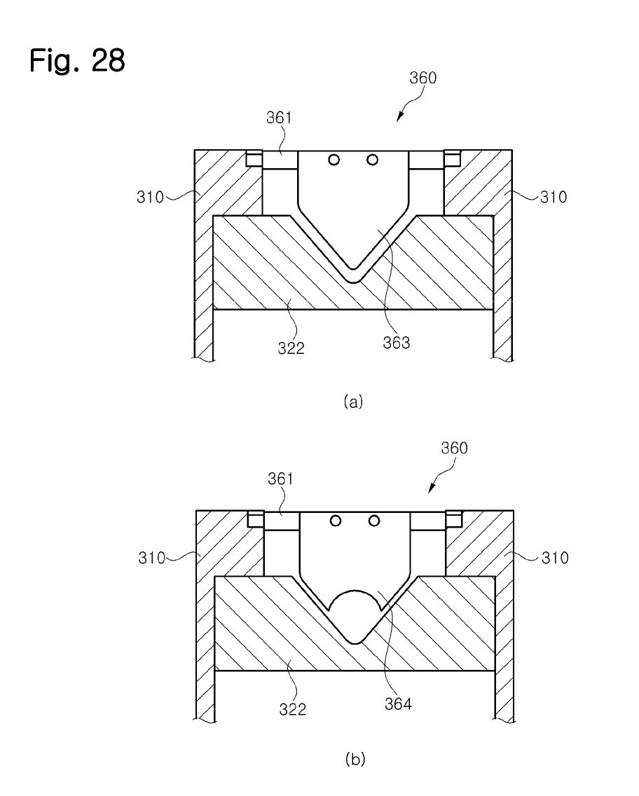

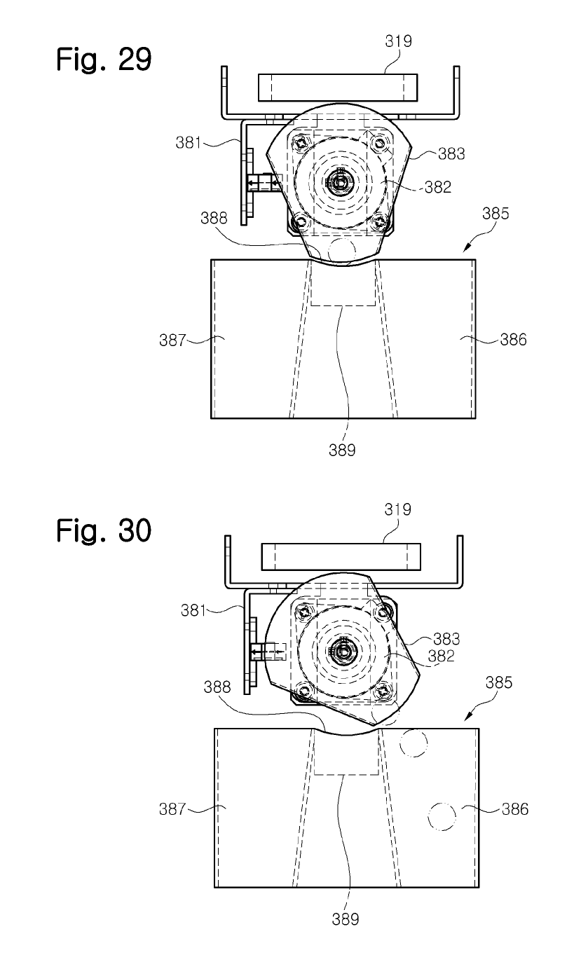

FIG. 27 is a schematic perspective view of a medicine dispenser according to a third exemplary embodiment of the present disclosure, FIG. 28 is a cross-sectional view of a main part of the medicine dispenser according to the third exemplary embodiment of the present disclosure, and FIG. 29 to FIG. 31 are front views illustrating operation of a medicine transfer unit of the medicine dispenser according to the third exemplary embodiment of the present disclosure.

As in the first or second embodiment, the medicine dispenser according to the third embodiment includes a frame 310 to which an openable gate unit is coupled, a vibration unit disposed at a lower portion of the frame 310 to move medicines via vibration, a support unit that supports the frame 310 and the vibration unit, a medicine input unit 340 disposed above the frame 310 to randomly supply desired medicines one pill at a time to the vibration unit, and a medicine transfer unit 380 that transfers the medicines to a hopper 130 (see FIG. 1) when the medicines are discharged one pill at a time through the vibration unit.

In the medicine dispenser according to the third embodiment, the frame, the vibration unit, the support unit and the medicine input unit are the same as those of the first and second embodiments except that a pendulum is disposed on the plate and the medicine transfer unit is of a swing hopper type. Thus, the following description of the medicine dispenser according to the third embodiment will focus on the different features.

As shown in FIGS. 27 and 28, the frame 310 is provided with one or more swingable pendulums 360. The pendulums 360 are provided to the frame 31 to be freely swung by application of external force thereto and serve to uniformly spread medicines in the case in which the medicines overlap each other on the plate 322, which vibrates to move the medicines.

Each pendulum 360 includes a swing rod 361 placed on holding grooves 311 formed on the frame 310 and thin catch boards 363, 364 suspended from the swing rod and made of plastic or the like such that overlapped medicines can be uniformly spread by the catch boards 363, 364 while moving on the plate.

As shown in FIG. 28, the catch board 363 may be separated a distance from the groove section 324 of the plate 322 instead of completely adjoining the groove section.

As shown in FIG. 28(a), the catch board 363 may have a pentagonal shape with a V-shaped vertex corresponding to the groove section 324 of the plate 322. Alternatively, as shown in FIG. 28(b), the catch board 364 may be circularly cut at the center of a lower end thereof. The catch board 363 shown in FIG. 28(a) may be used to uniformly spread medicines having a small and flat shape when the medicines move in an overlapped state, and the catch board 364 shown in FIG. 28(b) may be used to uniformly spread medicines such as tablets or capsules having circular or elliptical shapes.

Although three pendulums 360 are shown in FIG. 27, the present disclosure is not limited in terms of the number of pendulums 360. Since the pendulums 360 are simply placed on the holding grooves of the frame 310, the pendulums 360 can be picked up and removed therefrom for maintenance or cleaning.

As shown in FIG. 29 to FIG. 31, the medicine transfer unit 380 according to the third embodiment include a detection unit for determining the number of medicines dropping from a container (not shown) which contains the medicines, and a transfer unit which transfers the dropped medicines to a packing unit (not shown).

The detection unit may include sensors arranged in a discharge passage 319 through which the medicines pass. The sensors arranged in the discharge passage 319 may measure the number of medicines falling through the discharge passage 319. The sensor may be a photosensor including a light emitting element and a light receiving element, as shown in FIGS. 23 and 24.

The discharge passage 319 is formed at an upper center thereof with a pin member (not shown) to instantaneously reduce a falling speed of the medicines such that the sensors in the discharge passage 319 can efficiently and accurately count the number of medicines falling through the discharge passage. Since the medicine moves over the pin member to the left or right of the pin member while falling through the discharge passage, the falling speed of the medicine can be instantaneously reduced. As a result, the medicine can be more securely sensed by the sensors in the discharge passage.

According to this embodiment, the detection unit may include a scale 389 instead or together with the sensors to measure the total weight of medicines placed thereon. The scale 389 may be mounted on a dividing hopper 385 of the transfer unit described below.

According to the embodiment, when data regarding medicines to be packed, for example, the weight of a single pill, is previously input to a controller (not shown), the number of medicines on the scale 389 may be obtained by dividing the total weight of the medicines measured by the scale 389 by the weight of the single medicine. In addition, the scale 389 may be used to determine whether the weight of the medicines is excessive or insufficient due to breakage of the medicine, such that the data regarding the medicines can be used in packing.

When the scale 389 and the sensors of the discharge passage 319 are used together as the detection unit, the number of medicines passing through the discharge passage 319 may be primarily measured and the total weight of the medicines may be secondarily measured by the scale 389, thereby enabling more accurate packing.

The transfer unit includes a swing hopper 383 acting as a compression unit that pushes the medicines towards a packing unit (not shown) to transfer the medicines thereto, as shown in FIG. 30 or pushes the medicines towards a recovery unit (not shown) to transfer the medicines thereto, as shown in FIG. 31.

The swing hopper 383 may be swung by a motor 382 of the frame 381 in opposite directions, that is, in the left or right direction in FIG. 29 to FIG. 31.

The dividing hopper 385 may be located under the swing hopper 383. The dividing hopper 385 includes a packing passage 387 connected to the packing unit and a recovery passage 387 connected to the recovery unit. A medicine holding section 388 may be formed between the packing passage 386 and the recovery passage 387 of the dividing hopper 385 so as to allow falling medicines to temporarily remain thereon. The scale 389 described above may be provided to the medicine holding section 388. The packing passage 386, the recovery passage 387 and the medicine holding section 388 may be integrally formed with one another.

The packing unit located downstream of the packing passage 386 may be, for example, the packing unit 150 (see FIG. 1) of the conventional automatic packing machine.

Further, the recovery unit located downstream of the recovery passage 387 is provided to recover and reuse medicines instead of packing the medicines when the number of medicines temporally remaining on the medicine holding section 388 exceeds the number of medicines to be packed. Additionally, when the total weight of the medicine measured by the scale 389 on the medicine holding section 388 is excessively low or high, it is determined that bad medicine is included therein and the medicines may be recovered by the recovery unit to discard the medicines instead of packing. The recovery unit may be a simple container capable of receiving medicines.

An upper surface of the medicine holding section 388 may have an arcuate shape in a front view so as not to create a gap between the upper surface of the medicine holding section 388 and a lower surface of the swing hopper 383. Further, the lower surface of the swing hopper 383 may also have an arcuate shape corresponding to the upper surface of the medicine holding section 388.

If it is determined that the medicines placed on the medicine holding section 388 are provided for packing and the number of medicines thereon is accurate, the swing hopper 383 is swung towards the packing passage 386 to push and drop the medicines on the medicine holding section 388 into the packing passage 386. If it is determined that the number of medicines on the medicine holding section is inaccurate, the swing hopper 383 is swung towards the recovery passage 387 to push and drop the medicines on the medicine holding section 388 into the recovery passage 387. Since each of the packing passage 386 and the recovery passage 387 is open at one side thereof, that is, at an upper side thereof, it is possible to push and drop the medicines into the packing passage 386 or into the recovery passage 387 simply using the swing hopper 383.

As such, since the upper surface of the medicine holding section 388 and the lower surface of the swing hopper 383 have the arcuate shapes corresponding to each other, a gap is not created between the upper surface of the medicine holding section 388 and the lower surface of the swing hopper 383 when the swing hopper 383 swings towards the packing passage 386 or the recovery passage 387, so that it is possible to prevent medicine having a small size from remaining on the upper surface of the medicine holding section 388.

Further, since the upper surface of the medicine holding section 388 has a concavely arcuate shape, the medicines can be gathered towards the center of the medicine holding section 388. As a result, since the weight of the medicines is distributed over an inner wall of the swing hopper 383, it is possible to prevent a measurement error when the scale 389 measures the weight of the medicines.

Although not shown in the drawings, the swing hopper 383 may also have an arcuate upper surface to prevent interference with the discharge passage 319, and the lower surface of the discharge passage has an arcuate shape corresponding to the upper surface of the swing hopper 383.

Next, a medicine discharging method through the medicine transfer unit of the medicine dispenser according to the third embodiment will be described.

First, medicines to be packed are individually moved from a medicine container and temporarily remaining at a certain place, that is, on the medicine holding section 388. Since the medicines are moved one pill at a time, that is, dropped one pill at a time, the number of medicines on the medicine holding section 388 increases one at a time.

When the number of medicines on the medicine holding section 388 equals the number of medicines to be packed, vibration of the plate 322 is stopped to stop movement of the medicines, and the medicines on the medicine holding section 388 are pushed towards the packing passage 386 connected to the packing unit by the swing hopper 383 acting as a pushing unit. Since the packing passage 386 is in an open state, the medicines pushed towards the packing passage 386 are dropped and delivered to the packing unit.

In the medicine discharging method according to the embodiment, if the number of medicines on the medicine holding section is less than the number of medicines to be packed, the dispenser continues to operate until the number of medicines on the medicine holding section equals the number of medicines to be packed. If two or more medicines are undesirably transferred at the same time such that the number of medicines on the medicine holding section exceeds the number of medicines to be packed, the medicines gathered on the medicine holding section 388 are pushed towards the recovery passage 387 connected to the recovery unit by the swing hopper 383 acting as the pushing unit.

Since the recovery passage 387 is in an open state, the medicines pushed towards the recovery passage 387 are dropped and delivered to the recovery unit, so that the medicines in the recovery unit are not packed.

The number of medicines remaining or gathered on the medicine holding section 388 may be measured by one or both of the following methods. Specifically, the number of medicines may be measured by a method of detecting the number of medicines using the photosensors when the medicines pass through the discharge passage and/or a method of measuring the weight of medicines on the medicine holding section 388 using the scale 389 provided to the medicine holding section 388.

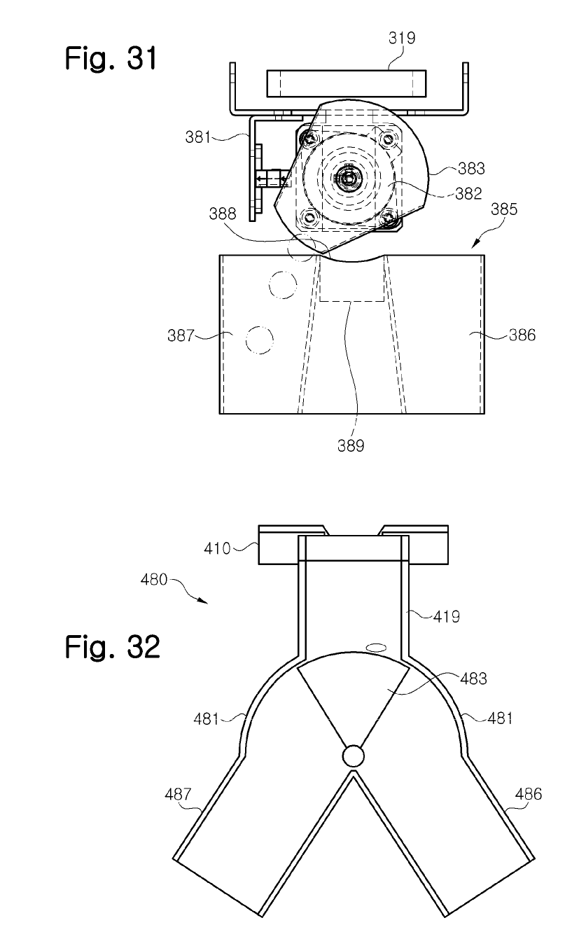

Next, a medicine transfer unit of a medicine dispenser according to a fourth exemplary embodiment of the present disclosure will be described with reference to FIG. 32 to FIG. 34.

FIG. 32 to FIG. 34 are front views illustrating operation of the medicine transfer unit of the medicine dispenser according to the fourth exemplary embodiment of the present disclosure.

The medicine dispenser according to the fourth embodiment has the same configuration as that of the first to third embodiments except for a medicine transfer unit 480, and the description of the medicine dispenser according to the fourth embodiment will focus on the medicine transfer unit 480.

Referring to FIG. 32 to FIG. 34, the medicine transfer unit 480 of the fourth embodiment includes a detection unit for determining the number of medicines dropping from a container (not shown) which contains the medicines, and a transfer unit which transfers the dropped medicines to a packing unit (not shown).

The detection unit may include sensors 410 arranged in a discharge passage 419 through which the medicines pass. The sensors arranged in the discharge passage 419 may measure the number of medicines falling through the discharge passage 419. The sensor may be a photosensor including a light emitting element and a light receiving element, as shown in FIGS. 23 and 24.

The transfer unit includes a medicine holding member 483 that allows falling medicines to temporarily remain thereon and then transfers the medicines towards the packing unit (not show) as shown in FIG. 33 or towards a recovery unit (not shown) as shown in FIG. 34.

The medicine holding member 483 may be swung by a motor (not shown) in opposite directions, that is, in the left or right direction in FIG. 32 to FIG. 34. A packing passage 486 connected to the packing unit and a recovery passage 487 connected to the recovery unit may be formed under the medicine holding member 483.

The packing unit located downstream of the packing passage 486 may be, for example, the packing unit 150 (see FIG. 1) of the conventional automatic packing machine.

Further, the recovery unit located downstream of the recovery passage 487 is provided to recover and reuse medicines instead of packing the medicines, when the number of medicines temporally placed on the medicine holding member 483 exceeds the number of medicines to be packed. The recovery unit may be a simple container capable of receiving medicines.

The medicine holding member 483 may have a fan-shaped cross-section with a rotational shaft located as a vertex of the fan shape, and an upper surface of the medicine transfer unit and an inner surface of the body 481 around the medicine holding member 483 may have arcuate shapes corresponding to each other in a front view so as not to create a gap between the upper surface of the medicine holding member 483 and the inner surface of the body 481 when the medicine holding member 483 is swung.

If it is determined that the medicines placed on the medicine holding member 483 are provided for packing and the number of medicines thereon is accurate, the medicine holding member 483 is swung opposite the packing passage 486 and opens the packing passage 486, which has been closed by the medicine holding member 483. Although the medicine holding member 483 swings inside the body 481, the medicines on the medicine holding member 483 are dropped into the packing passage 486 by the body 481 since there is no gap between the medicine holding member 483 and the body 481.

If it is determined that the number of medicines on medicine holding member 483 is inaccurate, the medicine holding member 483 swings opposite the recovery passage 487 and opens the recovery passage 487, which has been closed by the medicine holding member 483. Although the medicine holding member 483 swings inside the body 481, the medicines on the medicine holding member 483 are dropped into the recovery passage 487 by the body 481 since there is no gap between the medicine holding member 483 and the body 481.

As such, since the upper surface of the medicine holding member 483 and the body 481 have the arcuate shapes corresponding to each other, a gap is not created between the upper surface of the medicine holding member 483 and the body 481 when the medicine holding member 483 swings towards the packing passage 486 or the recovery passage 487, so that it is possible to prevent a medicine having a small size from remaining on the upper surface of the medicine holding member 483.

Next, a method for discharging medicines through the medicine transfer unit of the medicine dispenser according to the fourth embodiment will be described.

First, medicines to be packed are individually moved from a medicine container and temporarily remain at a certain place, that is, on the medicine holding member 483. Since the medicines are moved one pill at a time, that is, are dropped one pill at a time, the number of medicines on the medicine holding member 483 increases one at a time.

When the number of medicines on the medicine holding member 483 equals the number of medicines to be packed, vibration of the plate is stopped to stop movement of the medicines, and the medicine holding member 483 is swung opposite the packing passage 486 to transfer the medicines towards the packing passage. The medicines transferred towards the packing passage 486 are dropped and delivered to the packing unit.

In the medicine discharging method according to the embodiment, if the number of medicines on the medicine holding member is less than the number of medicines to be packed, the dispenser continues to operate until the number of medicines on the medicine holding section equals the number of medicines to be packed. If two or more medicines are undesirably transferred at the same time such that the number of medicines on the medicine holding member exceeds the number of medicines to be packed, the medicine holding member 483 is swung opposite the recovery passage 487 to transfer the medicines towards the recovery passage 487 connected to the recovery unit. The medicines transferred towards the recovery passage 487 are dropped and delivered to the recovery unit

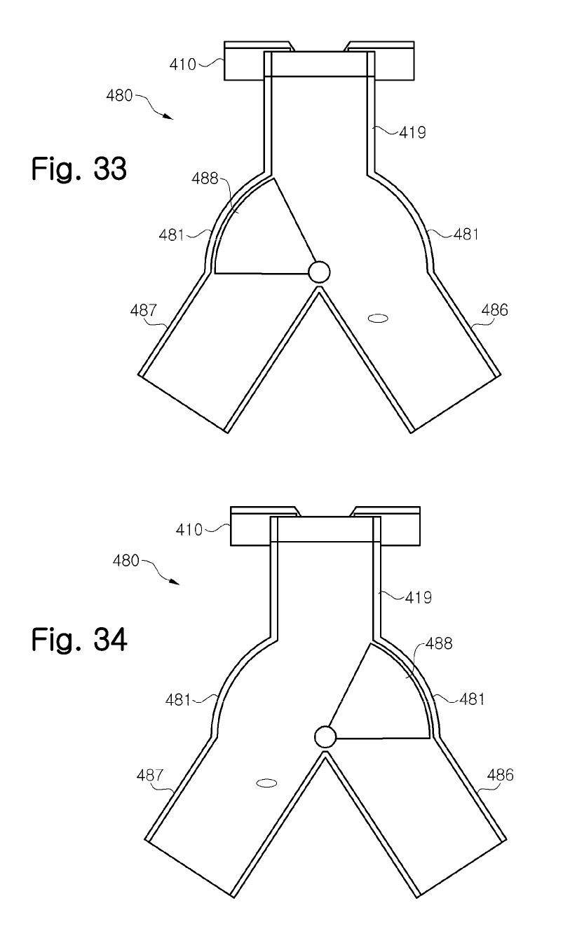

Next, a medicine transfer unit of a medicine dispenser according to a fifth exemplary embodiment of the present disclosure will be described with reference to FIG. 35 to FIG. 38.

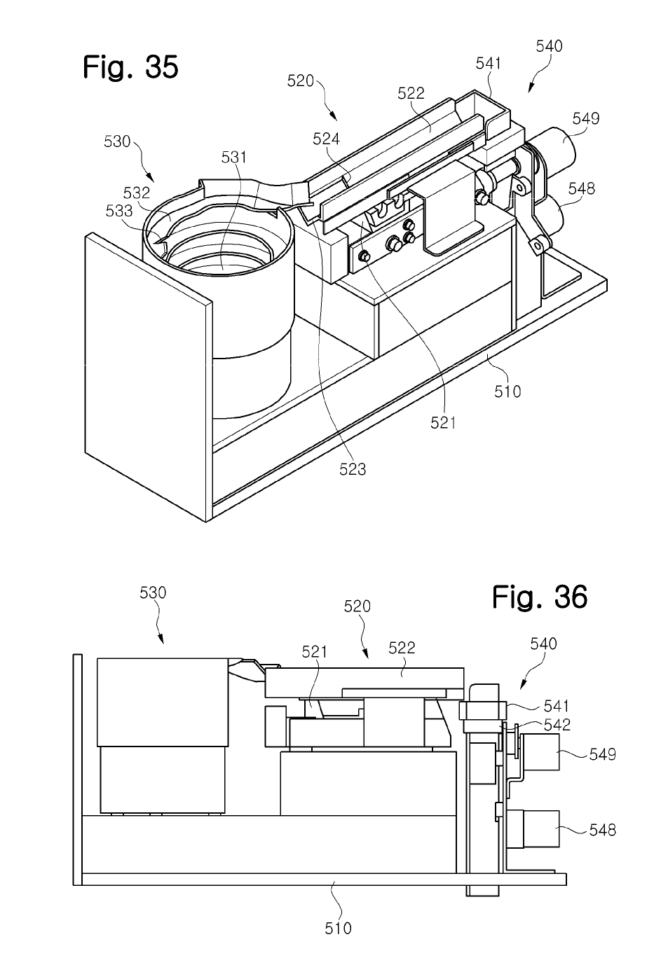

Referring to FIG. 35 and FIG. 36, the medicine dispenser D according to the fifth exemplary embodiment includes a frame 510, a vibration unit 520 mounted on the frame 510 to move medicines via vibration, a medicine input unit 530 located upstream of the vibration unit 520 on the frame 510 to supply desired medicines one pill at a time to the vibration unit 520, and a medicine transfer unit 540 that transfers the medicines to a hopper 130 when the medicines are discharged one pill at a time through the vibration unit 520.

The vibration unit 520 includes a vibrator 521 for generating vibration and a plate 522 attached to the vibrator 521 to vibrate together with the vibrator. The vibrator 521 may have any configuration known in the art so long as the vibrator can move the plate 522 in a linear direction, and a detailed description thereof will thus be omitted.

The plate 522 is vibrated by the vibrator 521, thereby minutely moving medicines thereon. The plate 522 includes a groove section 523 that moves the medicines to a discharge passage 542 of a medicine transfer unit 540.

The plate 522 is slightly inclined towards the side to which the discharge passage 542 is attached, so that the medicines on the plate 522 can be gradually moved towards the discharge passage 542 as the plate 522 is vibrated by the vibration unit

The groove section 523 includes at least one inclined plane 524, which forms at least one step on the bottom of the groove section 523. While a medicine passes through the inclined plane 524, the moving speed of the medicine increases, causing the medicine to be further separated from another medicine that immediately follows the medicine. As such, the inclined plane 524 on the groove section 523 separates the medicines from each other when discharged to the outside, so that discharge of the medicines can be accurately controlled.

The groove section 523 may have a U or V-shaped cross section so as to allow the medicines to move along a central line of the groove section 523. Further, when the plate 522 is formed with a plurality of inclined planes 524, the inclined planes may be designed to have the same or different angles, as needed.

The plate 522 may be formed of a metallic material, a non-metallic material, or a combination thereof. In particular, since the moving speed of the medicines having different shapes can be changed depending on the kind of material forming an upper surface of the plate 522 contacting the medicines, the material of the plate 522 may be selected in consideration of the moving speed of the medicines having different shapes.

As the medicine input unit 530, a cylindrical feeder may be mounted on the frame 510 to move medicines along a spiral path. Thus, when medicines having different shapes are provided into the receiving section 531 of the medicine input unit 530 at the same time, the medicines move to the outside of the receiving section 531 along the spiral path 532 extending from the bottom of the receiving section 531. As a result, while moving parallel to each other along the spiral path 532 in the cylindrical feeder provided as the medicine input unit 530, the medicines having different shapes may be transferred, that is, dropped, from the cylindrical feeder to the plate 522, and then move on the plate 522.

The spiral path 532 may be formed with at least one crevice 533, which allows one of two medicines moving parallel to each other along the spiral path 532 to fall into and return back to the receiving section 531 while passing through the crevice 533. For this purpose, the crevice 533 may be formed at an inner edge of the spiral path 532.

When moving to a distal end of the plate 522, the medicine having a different shape may be transferred to the outside through the medicine transfer unit 540. The medicine transfer unit 540 includes the discharge passage 542 on which a detection unit 541 for measuring the number of discharged medicines is mounted, a packing passage 543 through which the discharged medicines are transferred towards the packing unit 150 if it is determined based on the measurement result of the detection unit 541 that the number of medicines are accurate, and a recovery passage 544 through which the discharged medicines are transferred to a recovery barrel 545 if it is determined, based on the measurement result of the detection unit 541, that the number of medicines is inaccurate.

The detection unit provided to the discharge passage 542 to detect the number of medicines dropping from the plate 522 may be, for example, a photosensor including a light emitting element and a light receiving element.

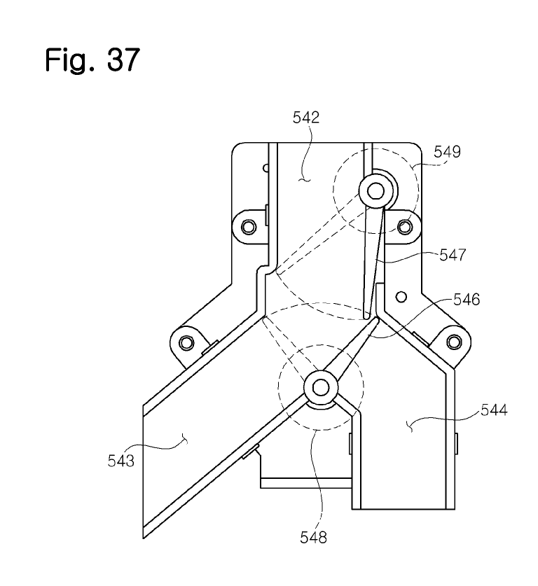

Referring to FIG. 37, an opening/closing member 546 may be provided to inlets of the packing passage 543 and the recovery passage 544 to selectively open one of the packing passage 543 and the recovery passage 544, and a holding member 547 may be disposed in the discharge passage 542 downstream of the opening/closing member 546 to allow medicines, the number of which is detected, to temporarily remain on the holding member. The opening/closing member 546 may be rotated within a predetermined angle by an opening/closing motor 548 and the holding member 547 may also be rotated within a predetermined angle by a holing motor 549.

As indicated by a solid line in FIG. 37, the holding member 547 is rotated in the counterclockwise direction and opened to supply the medicines downwards, and the opening/closing member 546 is rotated in the clockwise direction to open the packing passage 543 while closing the recovery passage 544.

As indicated by a dotted line in FIG. 37, the holding member 547 is rotated in the clockwise direction to close the discharge passage 542 so that the medicines can remain on the holding member 547. Further, as indicated by the dotted line in FIG. 37, the opening/closing member 546 is rotated in the counterclockwise direction to close the packing passage 543 while opening the recovery passage 544.

Next, a method of discharging medicines through the medicine transfer unit 540 of the medicine dispenser D according to the fifth exemplary embodiment will be described.

First, medicines are moved to the medicine transfer unit 540 through the medicine input unit 530 and the plate 522 of the vibration unit 520 and pass through the discharge passage 542. Here, when passing through the detection unit 541 disposed in the discharge passage 542, the detection unit 541 measures the number of medicines falling through the discharge passage 542. At this time, since the holding member 547 is rotated to close the discharge passage 542, all of the dropping medicines remain on the holding member 547.

If the number of medicines placed on the holding member 547 equals a predetermined number of medicines, that is, the number of medicines to be packed by a single medicine package, the opening/closing member 546 is rotated to open the packing passage 543 while closing the recovery passage 544. Then, as the holding member 547 is rotated to open the discharge passage 542, the medicines temporarily remaining on the holding member 547 are dropped downwards towards the packing passage 543.

The medicines supplied into the packing passage 543 are supplied to the packing unit 150 through the hopper 130 of the automatic packing machine and are finally packed by the packing unit 150.

On the contrary, if the number of medicines placed on the holding member 547 equals a predetermined number of medicines, that is, the number of medicines to be packed by a single medicine package, the opening/closing member 546 is rotated to open the recovery passage 544 while closing the packing passage 543. Then, as the holding member 547 is rotated to open the discharge passage 542, the medicines on the holding member 547 are dropped downwards towards the recovery passage 544.

The medicines supplied into the recovery passage 544 are supplied to the recovery barrel 545 so to be reused.

In the medicine discharging method according to the fifth embodiment, if the number of medicines on the holding member 547 is less than the number of medicines to be packed, the dispenser continues to operate until the number of medicines on the medicine holding section equals the number of medicines to be packed. If two or more medicines are undesirably transferred at the same time such that the number of medicines on the medicine holding member exceeds the number of medicines to be packed, the medicines gathered on the holding member 547 may be transferred towards the recovery passage 544.

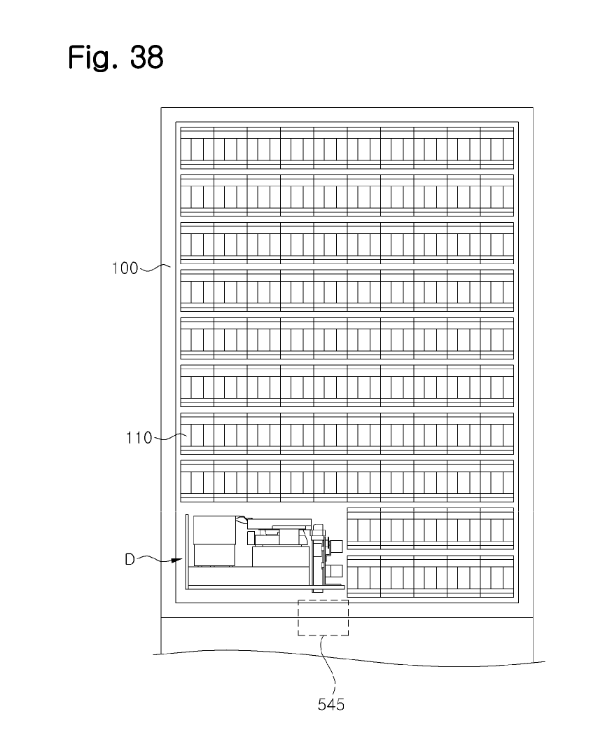

As shown in FIG. 38, the medicine dispenser D according to this embodiment may be arranged together with cassettes 110 within the body of the automatic packing machine.

When installed in the automatic packing machine, the medicine dispenser D is disposed together with the plural cassettes 110 containing medicines in the form of tablets or capsules having various sizes and shapes inside the body 100. In this case, the medicine dispenser D may be disposed under the cassettes 110.

One or more of the medicine dispensers according to the embodiments may be installed in the automatic packing machine. Obviously, the medicine dispenser according to the embodiments may be used independent of the automatic packing machine.

When installed in the automatic packing machine, the medicine dispenser is configured to supply a desired number of medicines towards the packing unit according to a packing cycle by which the medicines received in the cassettes 110 within the automatic packing machine are discharged and packed.

When a plurality of medicine dispensers is installed in a single automatic packing machine to discharge different kinds of medicines for packing at the same time, these medicine dispensers may be disposed to discharge the medicines having different shapes to a common hopper 130 (see FIG. 1).

It should be understood that the medicine dispenser according to the embodiments of the present disclosure may be used to dispense not only medicines having different shapes but also general medicines such as circular or elliptical tablets or capsules.

The various embodiments described above can be combined to provide further embodiments. All of the patents, patent application publications, patent applications, foreign patents, foreign patent applications and non-patent publications referred to in this specification and/or listed in the Application Data Sheet are incorporated herein by reference, in their entirety. Aspects of the embodiments can be modified, if necessary, to employ concepts of the various patents, applications and publications to provide yet further embodiments.

These and other changes can be made to the embodiments in light of the above-detailed description. In general, in the following claims, the terms used should not be construed as limiting the claims to the specific embodiments disclosed in the specification and the claims, but should be construed as including all possible embodiments along with the full scope of equivalents to which such claims are entitled. Accordingly, the claims are not limited by the disclosure.

1. A medicine dispenser capable of discharging medicines one pill at a time by vibration, comprising:
a frame; and
a medicine transfer unit attached to the frame and transferring medicines one pill at a time to an outside of the medicine dispenser, the medicine transfer unit comprising a detection unit that detects the number of medicines dropping from a medicine container to be packed, and a transfer unit that pushes the medicines, the number of which is detected by the detection unit, into a packing passage connected to a packing unit to transfer the medicines to the packing unit.

2. The medicine dispenser of claim 1, wherein when the number of medicines detected by the detection unit exceeds the number of medicines to be packed, the dropped medicines are pushed into a recovery passage to be recovered instead of being packed.

3. The medicine dispenser of claim 1, wherein the detection unit comprises sensors arranged in the discharge passage through which the medicines pass when dropping from the container.

4. The medicine dispenser of claim 1, wherein the detection unit comprises a scale that receives the dropped medicines and measures a total weight of the dropped medicines.

5. The medicine dispenser of claim 1, wherein the transfer unit comprises a swing hopper swingable in opposite directions to push the dropped medicines into the packing passage to transfer the medicines towards the packing unit or to push the dropped medicines into the recovery passage to transfer the medicines towards the recovery unit.

6. The medicine dispenser of claim 1, further comprising:
a vibration unit mounted on the frame to generate vibration to move the medicines, the vibration unit comprising a vibrator for generating vibration and a plate attached to the vibrator to vibrate together with the vibrator.

7. The medicine dispenser of claim 1, further comprising:
a pendulum rotatably mounted on the frame to uniformly spread the medicines when the medicines are moved in an overlapped state by vibration.

8. The medicine dispenser of claim 1, wherein the frame comprises a gate unit, an opening degree of which is adjusted to allow the medicines to pass one pill at a time therethrough, and a drive unit that drives the gate unit to open or close the gate unit.

9. A medicine dispenser capable of discharging medicines one pill at a time by vibration, comprising:
a frame;
a vibration unit generating vibration to move medicines;
a support unit supporting the frame and the vibration unit while preventing the vibration from being transferred from the vibration unit to the frame; and
a pendulum rotatably mounted on the frame to uniformly spread the medicines when the medicines are moved in an overlapped state by the vibration, the pendulum comprising a swing rod swingably placed on holding grooves formed on the frame and a catch board suspended from the swing rod to uniformly spread the medicines when the medicines are moved in an overlapped state on the plate.

10. A medicine dispenser capable of discharging medicines one pill at a time by vibration, comprising:
a frame; and
a medicine transfer unit attached to the frame and transferring medicines one pill at a time to an outside of the medicine dispenser,
the medicine transfer unit comprising a detection unit that detects the number of medicines dropping from a medicine container to be packed, and a transfer unit that transfers the medicines, the number of which is detected by the detection unit, to a packing passage connected to a packing unit after making the medicines temporarily remaining in the transfer unit.

11. A medicine dispenser capable of discharging medicines one pill at a time by vibration, comprising:
a frame;
a vibration unit mounted on the frame and moving medicines by vibration; and
a medicine transfer unit transferring the medicines discharged one pill at a time from the vibration unit to an outside of the medicine dispenser,
the medicine transfer unit comprising a detection unit provided to a discharge passage, through which the medicines discharged from the vibration unit pass, to detect the number of medicines passing through the discharge passage, a holding member causing the medicines, which have passed through the detection unit, to temporarily remain on the holding member inside the discharge passage, and an opening/closing member located downstream of the holding member to open a packing passage if the number of medicines measured by the detection unit and placed on the holding member equals a predetermined number of medicines, and to open a recovery passage if the number of medicines measured by the detection unit and placed on the holding member differs from the predetermined number of medicines.

12. The medicine dispenser of claim 11, wherein the opening/closing member is rotatably located between the packing passage and the recovery passage to open the packing passage while closing the recovery passage if the number of medicines on the holding member equals the predetermined number of medicines and to open the recovery passage while closing the packing passage if the number of medicines on the holding member differs from the predetermined number of medicines.

13. A medicine discharging method capable of accurately discharging a specific number of medicines to be packed, comprising:
causing medicines to temporarily remain at a certain place when the medicines to be packed are individually moved from a medicine container, followed by pushing the medicines into a packing unit, if the number of medicines remaining at the certain place equals the number of medicines to be packed.

14. A medicine discharging method capable of accurately discharging a specific number of medicines to be packed, comprising:
causing medicines to temporarily remain at a certain place by a holding member when the medicines to be packed are individually moved from a medicine container;
opening a packing passage located downstream of the holding member to supply the medicines towards a packing unit through the packing passage, if the number of medicines remaining at the certain place equals the number of medicines to be packed; and
releasing a remaining state of the medicines to transfer the medicines towards the open packing passage.

15. An automatic packing machine for consecutively packing various kinds of medicines into doses according to prescriptions, comprising:
a plurality of cassettes arranged at an upper portion of a body of the automatic packing machine and containing medicines having various sizes and shapes;
the medicine dispenser according to claim 1 capable of discharging the medicines one pill at a time by vibration;
a hopper disposed at a lower portion of the body to collect the medicines dropping from the medicine dispenser through the cassettes;
a printer printing various data regarding the medicines on a surface of a wrapping paper for packing the medicines; and
a packing unit for packing the medicines collected by the hopper using the wrapping paper.
